(19) United States
(12) Patent Application Publication
(10) Pub. No.: US 2020/0292878 A1
(43) Pub. Date: Sep. 17, 2020

(54) LOUVER FILM, PLANAR LIGHT SOURCE DEVICE, AND LIQUID CRYSTAL DISPLAY DEVICE

(71) Applicant: FUJIFILM Corporation, Tokyo (JP)

(72) Inventors: Megumi SEKIGUCHI, Kanagawa (JP); Takashi TAMADA, Kanagawa (JP); Shinya WATANABE, Kanagawa (JP)

(73) Assignee: FUJIFILM Corporation, Tokyo (JP)

(21) Appl. No.: 16/885,749

(22) Filed: May 28, 2020

Related U.S. Application Data
(63) Continuation of application No. PCT/JP2018/043575, filed on Nov. 27, 2018.

(30) Foreign Application Priority Data
Dec. 4, 2017 (JP) 2017-232869
May 25, 2018 (JP) 2018-100798

(51) Int. Cl. G02F 1/1335; F21S 2/00; G02B 5/00

(52) U.S. Cl. CPC G02F 1/133536; G02F 2201/343; G02B 5/003; F21S 2/00

(57) ABSTRACT

A louver film, a planar light source device, and a liquid crystal display device enables further improvement of directivity for visibility while light use efficiency is maintained and also enable improvement of viewing angle contrast and halo. The louver film includes a plurality of lenses which are arranged at a constant pitch on an emission side of a light source; a first support disposed on a side closer to the light source than the lenses and has a thickness greater than or equal to the pitch of the lenses and a refractive index of 1.5 or greater; and a light reflecting layer disposed on a side closer to the light source than the first support and has a reflectivity of 90% or greater and openings on optical axes of the plurality of lenses, and the opening ratio of each opening is in a range of 30% to 70%.

### CROSS-REFERENCE TO RELATED APPLICATIONS

This application is a Continuation of PCT International Application No. PCT/JP2018/043575 filed on Nov. 27, 2018, which claims priority under 35 U.S.C. § 119(a) to Japanese Patent Application No. 2017-232869 filed on Dec. 4, 2017 and Japanese Patent Application No. 2018-100798 filed on May 25, 2018. Each of the above applications is hereby expressly incorporated by reference, in its entirety, into the present application.

### BACKGROUND OF THE INVENTION

### 1. Field of the Invention

The present invention relates to a louver film, and a planar light source device and a liquid crystal display device which comprise a louver film.

### 2. DESCRIPTION OF THE RELATED ART

Since liquid crystal display devices (hereinafter, also referred to as liquid crystal displays (LCDs)) have a low power consumption, the use thereof as space-saving image display devices has increased each year. Each liquid crystal display device is typically configured of a planar light source device and a liquid crystal panel. Further, similar to liquid crystal display devices, since organic electro luminescence (EL) display devices also have a low power consumption, the use thereof as space-saving image display devices has increased each year. The above-described various image display devices are required to have a wide viewing angle as a typical viewing angle characteristic.

However, display images of an image display device may not be projected in a place where the display images are originally intended to be projected depending on the installation location of the image display device. In this case, it is necessary to limit the viewing angle of the image display device. For example, in a case where display images containing highly confidential documents, images, and personal information, and information with high secrecy such as passwords are displayed on an image display device, the viewing angle needs to be limited so as not to be seen by others. As described above, it is necessary to limit the viewing angle depending on the use of the image display device.

As a method of limiting the viewing angle described above, a method of disposing a louver film has been suggested (JP4856805B). Further, JP4389938B discloses an optical sheet provided with a light reflection portion on the back surface of a lenticular lens.

### SUMMARY OF THE INVENTION

Even in a case where the viewing angle is limited as described above, it is desired that the display image is bright as the basic performance of an image display device. However, since the light use efficiency is low and the brightness of a display image becomes lower in the louver film of JP4856806B, the image is darkened.

In the optical sheet disclosed in JP4389938B, the opening ratio of an opening and the distance between an opening and a lens portion are defined using expressions in order to reduce the sidebands. However, JP4389938B also describes that it is not preferable to extremely increase the directivity.

In a case where the louver film is used for an in-vehicle monitor, it is necessary to further increase the directivity for visibility as compared with that in JP4389938B while the sideband is reduced. Further, in the case where the louver film is used for an in-vehicle monitor, it is necessary to control the direction of the directivity so that the directivity is not only directed to the front side.

Therefore, an object of the present invention is to provide a louver film, a planar light source device, and a liquid crystal display device in which the directivity for visibility has been further improved while light use efficiency is maintained.

As the result of intensive research repeatedly conducted by the present inventors in order to achieve the above-described object, a louver film which is used for a planar light source device, the film comprising: a plurality of lenses which are arranged at a constant pitch on an emission side of a light source; a first support which is disposed on a side closer to the light source than the lenses and has a thickness greater than or equal to the pitch of the lenses and a refractive index of 1.5 or greater; and a light absorbing layer which is disposed on a side closer to the light source than the first support, in which the light absorbing layer has a first opening and an opening ratio of the first opening is in a range of 30% to 70% was newly found, thereby completing the present invention.

Further, as the result of intensive research repeatedly conducted by the present inventors in order to achieve the above-described object, a louver film which is used for a planar light source device, the film comprising: a plurality of lenses which are arranged at a constant pitch on an emission side of a light source and have a refractive index of 1.65 to 1.9; a first support which is disposed on a side closer to the light source than the lenses and has a thickness smaller than the pitch of the lenses and a refractive index of 1.4 to 1.65; and a light absorbing layer which is disposed on a side closer to the light source than the first support, in which the light absorbing layer has a first opening, and an opening ratio of the first opening is in a range of 10% to 70% was newly found, thereby completing the present invention.

Here, the louver film is a film having improved directivity. Further, in a liquid crystal display device comprising a planar light source device that includes the film, the louver film is a film in which the directivity for visibility is improved as compared with a case where the film is not provided so that visual recognition, for example, in an oblique direction can be suppressed. In addition, the louver film is a film in which the viewing angle is limited and projection of an image in a region where the image is not intended to be displayed is improved.

The viewing angle is limited such that the visual recognition can be made in a certain angle range with respect to a surface of the louver film. For example, in a case where the brightness in a direction perpendicular to the surface of the louver film is used as a reference, the brightness in a direction inclined by 45° with respect to a line perpendicular to the surface of the louver film is lower than the reference brightness. In this case, the viewing angle is limited to be near the front side of the louver film. Conversely, in a case where the brightness in a direction inclined by 45° is higher than the reference brightness, the viewing angle is limited to an oblique direction of the louver film.

Further, the above-described light use efficiency indicates a value measured according to the following method.

On a light emission surface of a planar light source device, a brightness (Y0) measured for every degree from a polar angle of 0° (front direction) to a polar angle of 88° is obtained using a measuring device “EZ-Contrast XL88” (manufactured by ELDIM Co., Ltd.), and the maximum value of the brightness value is set as the maximum brightness. The maximum brightness is measured in a state (T0) where the louver film is not disposed on the planar light source device and in a state (T) where the louver film is disposed (T) thereon, and a ratio (T/T0) is calculated to obtain the maximum brightness ratio. The light use efficiency increases as the maximum brightness ratio increases.

Further, the above-described directivity indicates a value evaluated according to the following method.

In the planar light source device, the brightness (Y0) measured for every degree from a polar angle of 0° (front direction) to a polar angle of 88° is obtained using a measuring device “EZ-Contrast XL88” (manufactured by ELDIM Co., Ltd.), and the minimum polar angle at which the brightness value becomes half the brightness value in the front direction is set as the half width at half maximum. Further, the directivity increases as the half width at half maximum decreases.

Further, in the planar light source device, the brightness (Y0) measured for every degree from a polar angle of 0° (front direction) to a polar angle of 88° is obtained using a measuring device “EZ-Contrast XL88” (manufactured by ELDIM Co., Ltd.), and the ratio between the brightness value in the front direction and the minimum brightness value at a polar angle of 60° is calculated as an SN ratio (=brightness in front direction/minimum brightness value at polar angle of 60°). The S/N ratio is evaluated as skirting. As the SN ratio increases, the skirting becomes improved so that the directivity becomes higher.

In one aspect, the refractive index of the first support is 1.6 or greater.

In the aspect, the louver film further comprises a light reflecting layer which is disposed on a side closer to the light source side than the light absorbing layer and comprises a second opening, in which the light reflecting layer has a reflectivity of 90% or greater, an opening ratio of the second opening is the same as the opening ratio of the light absorbing layer, the light absorbing layer and the light reflecting layer are disposed in a state in which the first opening and the second opening are aligned.

In the aspect, each of the first openings is provided for each of the lenses, and the first opening is deviated from an optical axis of the lens.

In the aspect, the first opening and the second opening are provided for each of the lenses, and the aligned first opening and second opening are deviated from an optical axis of the lens.

In the aspect, a second support is disposed on a side closer to the light source than the light absorbing layer.

In the aspect, the second support is disposed on a side closer to the light source than the light reflecting layer.

In the aspect, the light reflecting layer includes a cholesteric liquid crystal layer.

In the aspect, the second support has a refractive index of 1.6 or greater.

According to another aspect of the present invention, there is provided a planar light source device comprising: the louver film described above; and the light source.

In the aspect, the planar light source device further comprises a reflective type polarizer which is disposed between the louver film and the light source.

According to a still another aspect of the present invention, there is provided a liquid crystal display device comprising: the louver film; the planar light source device described above; and a liquid crystal panel.

According to the present invention, it is possible to provide a louver film which enables further improvement of directivity for visibility while light use efficiency is maintained, and a planar light source device and a liquid crystal display device which comprise the louver film.

### BRIEF DESCRIPTION OF THE DRAWINGS

FIG. 1 is a schematic cross-sectional view illustrating a schematic configuration of a planar light source device according to an embodiment of a first aspect of the present invention.

FIG. 2 is a schematic cross-sectional view illustrating a schematic configuration of a planar light source device according to an embodiment of a second aspect of the present invention.

FIG. 3 is a cross-sectional view schematically illustrating a first example of a louver film.

FIG. 4 is a perspective view schematically illustrating the first example of the louver film.

FIG. 5 is a cross-sectional view schematically illustrating a second example of a louver film.

FIG. 6 is a cross-sectional view schematically illustrating a third example of a louver film.

FIG. 7 is a cross-sectional view schematically illustrating a fourth example of a louver film.

FIG. 8 is a cross-sectional view schematically illustrating another example of a planar light source device.

FIG. 9 is a cross-sectional view schematically illustrating an example of a liquid crystal display device.

FIG. 10 is a cross-sectional view schematically illustrating another example of a liquid crystal display device.

FIG. 11 is a cross-sectional view schematically illustrating still another example of a liquid crystal display device.

FIG. 12 is a schematic view illustrating a condenser lens and a liquid crystal cell as viewed in an optical axis direction.

FIG. 13 is a cross-sectional view taken along line B-B of FIG. 12.

FIG. 14 is a cross-sectional view taken along line C-C of FIG. 12.

FIG. 15 is a cross-sectional view taken along line D-D of FIG. 12.

### DESCRIPTION OF THE PREFERRED EMBODIMENTS

The following description may be made based on representative embodiments of the present invention, but the present invention is not limited to such embodiments.

In the following description, “to” indicating numerical ranges includes the numerical values described on both sides. For example, in a case where s is in a range of a numerical value α to a numerical value β, the range of a is a range including the numerical value α and the numerical value β, and the range is expressed as “α≤ε≤β” using mathematical symbols.

Unless otherwise specified, the “angle expressed as a specific numerical value” and the angle of “parallel” include an error range generally accepted in the corresponding technical field. Further, the term “same” includes an error range generally accepted in the corresponding technical field.

[Louver Film]

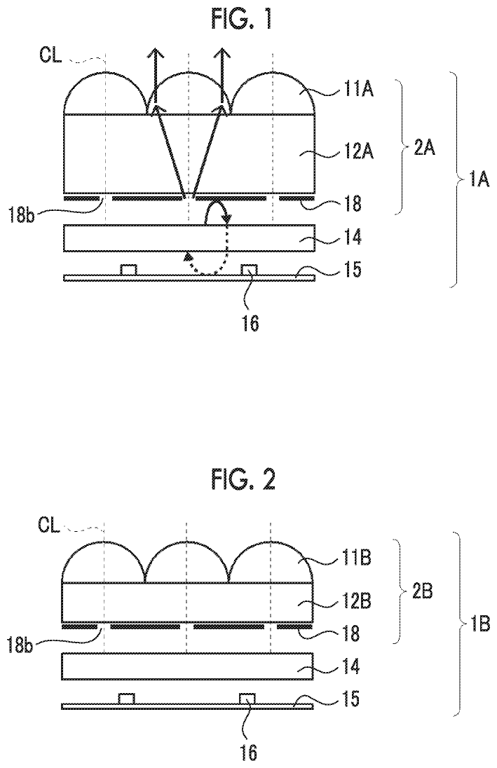

FIG. 1 is a schematic cross-sectional view illustrating a schematic configuration of a planar light source device 1 which includes a louver film 2A according to an embodiment of the first aspect of the present invention.

The louver film according to the embodiment of the present invention is a louver film 2A which is used for a planar light source device and includes a plurality of lenses 11A which are arranged at a constant pitch on an emission side of a light source 16; a first support 12A which is disposed on a side closer to the light source 16 than the lenses 11A, has a thickness greater than or equal to the pitch of the lenses 11A, and has a refractive index of 1.5 or greater, and a light absorbing layer 18 which is disposed on a side closer to the light source 16 than the first support 12B, in which the light absorbing layer 18 has a first opening 18b, and the opening ratio of the first opening 18b is in a range of 30% to 70%. For example, the first opening 18b of the light absorbing layer 18 is provided on optical axes CL of the plurality of lenses 11A.

The planar light source device 1A illustrated in FIG. 1 includes the louver film 2A described above, a diffusion plate 14 disposed on a side of the light absorbing layer 18 of the louver film 2A, the light source 16, and a reflection plate 15 in this order. For example, the first opening 18b is provided for each lens 11A, and the first opening 18b is provided for one lens 11A.

The following description is not intended to limit the present invention, and the reason why the louver film 2A according to the first embodiment described above enables further improvement of directivity for visibility while the light use efficiency is maintained is considered by the present inventors as follows.

In order to prevent a decrease in light use efficiency and to improve the directivity, the opening ratio of the first opening 18b of the light absorbing layer 18 is preferably 30% or greater, and the light usage rate is rapidly decreased in a case where the opening ratio thereof is less than 30%. Further, in a case where the opening ratio is greater than 70%, light is not condensed. In a case where the opening ratio is approximately 40%, the peak (sideband) of the light intensity becomes high at a polar angle of 35° or greater, and the light condensing effect becomes insufficient. In this case, by using a support having a higher refractive index than that of the lens, specifically, by setting the refractive index of the first support 12A to 1.5 or greater, the directivity of light passing through the first opening 18b of the light absorbing layer 18 is enhanced, and the generation of a sideband can be suppressed.

Further, the light absorbing layer 18 absorbs light reflected by the lens or the light reflecting layer 13 or light that is incident from the outside and is repeatedly reflected in the first support 12, and thus generation of stray light can be suppressed. In this manner, generation of a sideband can be suppressed.

Further, in a case where the thickness of the first support 12A is set to be greater than or equal to the pitch of the lens 11A described above and the refractive index of the first support 12A is set to 1.5 or greater, the directivity of light passing through the first opening 18b of the light absorbing layer 18 is enhanced, and light from adjacent openings other than the first opening on the optical axis CL of the lens 11A is not guided. As a result of the description above, the louver film 2A can reduce the sidebands and realize further improvement of the directivity for visibility while the light use efficiency is maintained. However, the description above includes inferences made by the present inventors and does not limit the present invention.

FIG. 2 is a schematic cross-sectional view illustrating a schematic configuration of a planar light source device 1B which includes a louver film 2B according to an embodiment of a second aspect of the present invention.

The louver film according to the embodiment of the present invention is a louver film 2B which is used for a planar light source device and includes a plurality of lenses 11B which are arranged at a constant pitch on an emission side of the light source 16 and have a refractive index of 1.65 to 1.9; a first support 12B which is disposed on a side closer to the light source 16 than the lenses 11B, has a thickness greater than or equal to the pitch of the lenses 11B, and has a refractive index of 1.4 to 1.65; and the light absorbing layer 18 which is disposed on a side closer to the light source 16 than the first support 12B, in which the light absorbing layer 18 has the first opening 18b, and the opening ratio of the first opening 18b is in a range of 10% to 70%.

The planar light source device 1B illustrated in FIG. 2 includes the louver film 2B described above, the diffusion plate 14 disposed on a side of the light reflecting layer 13 of the louver film 2B, the light source 16, and the reflection plate 15 in this order. For example, the first opening 18b is provided for each lens 11B, and the first opening 18b is provided for one lens 11B.

The following description is not intended to limit the present invention, and the reason why the louver film 2B according to the second embodiment described above enables further improvement of directivity for visibility while the light use efficiency is maintained is considered by the present inventors as follows.

In a case where the thickness of the first support 12B is smaller than the pitch of the lens 11B, light from adjacent openings other than the opening on the optical axis CL of the lens 11B is unlikely to be guided, the focal position of the lens 11B is greatly shifted to the outside of the first opening 18b of the light absorbing layer 18 (a side opposite to the lens 11B) even though the sidebands can be reduced, and thus the directivity is decreased. Meanwhile, in a case where the refractive index of the first support 11B is set to be greater than the refractive index of the lens 12B by setting the refractive index of the first support 12B to be in a range of 1.4 to 1.65 and setting the refractive index of the lens 11B to be in a range of 1.65 to 1.9, the focal position of the lens 11B can be brought closer to the first opening 18b of the light absorbing layer 18, the sidebands can be reduced, and further improvement of the directivity can be realized while the light use efficiency is maintained. Further, in a case where the refractive index of the first support 11B is set to be greater than the refractive index of the lens 12B by setting the refractive index of the first support 11B to be in a range of 1.4 to 1.65 and setting the refractive index of the lens 12B to be in a range of 1.65 to 1.9, the viewing angle can be easily limited to be near the front side even in a case where light from adjacent openings other than the first opening 18b on the optical axis CL of the lens 11B is guided, and this leads to a decrease in sidebands.

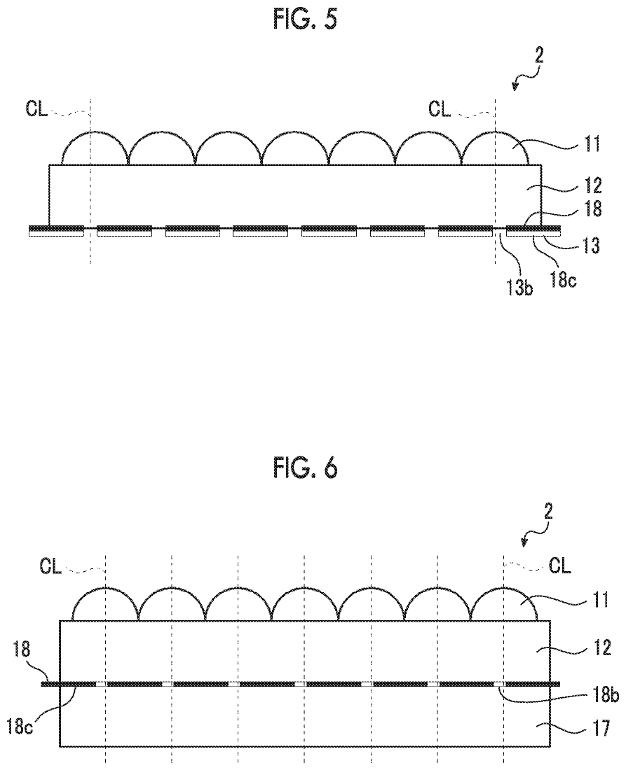

In addition, the light absorbing layer 18 absorbs light reflected by the lens or the light reflecting layer 13 (see FIG. 5) or light that is incident from the outside and is repeatedly reflected in the first support 12, and thus generation of stray light can be suppressed. In this manner, generation of a sideband can be suppressed. As a result of the description above, the louver film 2B can reduce the sidebands and realize further improvement of the directivity for visibility while the light use efficiency is maintained.

However, the description above includes inferences made by the present inventors and does not limit the present invention.

Hereinafter, the above-described louver film will be described in more detail.

In the following description, the louver film 2A according to the first embodiment and the louver film 2B according to the second embodiment will be collectively referred to as a louver film 2 in a case where the louver film 2A and the louver film 2B do not need to be distinguished from each other. Similarly, the planar light source device 1A and the planar light source device 1B will be collectively referred to as a planar light source device 1 in a case where the planar light source device 1A and the planar light source device 1B do not need to be distinguished from each other. Similarly, the lens 11A and the lens 11B will be collectively referred to as a lens 11 in a case where the lens 11A and the lens 11B do not need to be distinguished from each other. Similarly, the first support 12A and the first support 12B will be collectively referred to as a first support 12 in a case where the first support 12A and the first support 12B do not need to be distinguished from each other.

<Configuration of Louver Film>

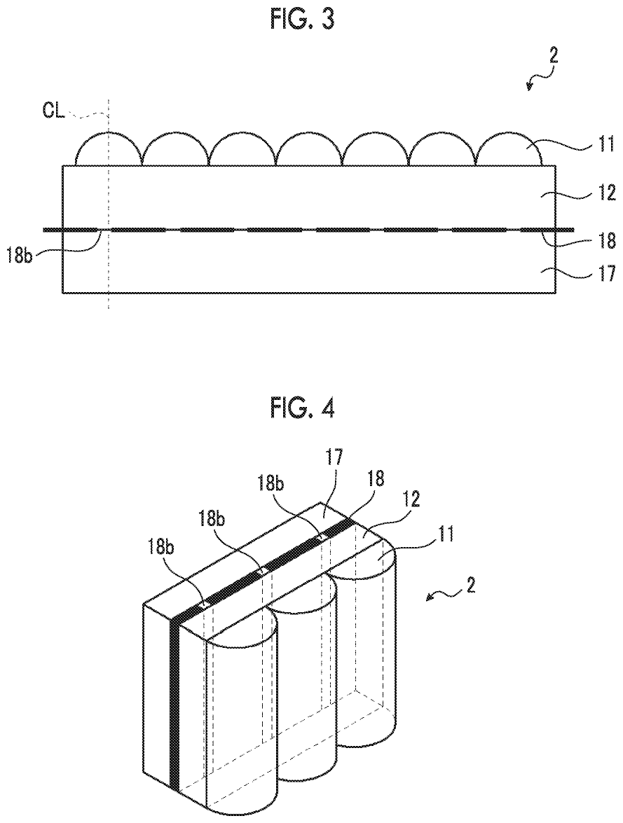

As the configuration of the louver film in a case where the louver film is used in a planar light source device, the louver film includes a plurality of lenses which are arranged on an emission side of a light source, a first support which is disposed on a side closer to the light source than the lenses, and a light absorbing layer which is disposed on a side closer to the light source than the first support and has a first opening on each optical axis of the plurality of lenses described above. As illustrated in FIG. 3, the second support 17 may be disposed on a side closer to the light source than the light absorbing layer 18.

In the louver film, for example, the lens 11 is a convex cylindrical lens having a semi-cylindrical shape, and the first opening 18b of the light absorbing layer 18 is a strip-shaped opening which extends in a direction at which the convex cylindrical lens having a semi-cylindrical shape is present, as illustrated in FIG. 4. One strip-shaped opening is provided for one convex cylindrical lens having a semi-cylindrical shape.

As the configuration of the louver film, the louver film 2A and the louver film 2B may be configured to be disposed on a side closer to the light source (not illustrated) than the first support 12 and to include the light reflecting layer 13 comprising the second opening 13b, as illustrated in FIG. 5.

The light reflecting layer 13 is provided on a rear surface 18c of the light absorbing layer 18 on a side opposite to the first support 12.

The light reflecting layer 13 has a reflectivity of 90% or greater, and the opening ratio of the second opening 13b is the same as that of the light absorbing layer 18. The light absorbing layer 18 and the light reflecting layer 13 have the same opening pattern. The light reflecting layer 13 and the light absorbing layer 18 are disposed in a state where the first opening 18b of the light absorbing layer 18 and the second opening 13b of the light reflecting layer 13 are aligned. Even in the configuration illustrated in FIG. 5, the louver film may be configured such that the second support 17 is disposed on a side closer to the light source than the light reflecting layer 13 as described above.

The louver film 2 illustrated in FIG. 3 may be configured such that the first opening 18b of the light absorbing layer 18 may be deviated from the optical axis CL of the lens 11 as in the louver film 2 illustrated in FIG. 6.

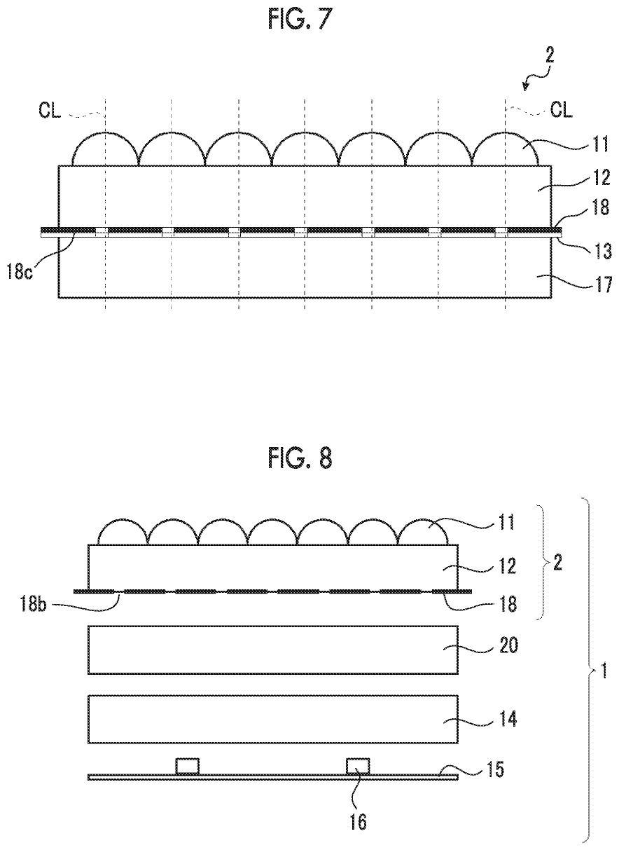

Further, the louver film 2 illustrated in FIG. 5 may be configured such that the center of the first opening 18b of the light absorbing layer 18 and the center of the second opening 13b of the light reflecting layer 13 are deviated from the optical axis CL of the lens 11 as in the louver film 2 illustrated in FIG. 7. By setting the center position of the opening as a position shifted from the optical axis CL of the lens, the direction of directivity can be adjusted.

Further, the expression “deviated from the optical axis CL of the lens 11” means that the optical axis CL does not pass through the center of the first opening 18b of the light absorbing layer 18. In a case where the amount of shift of the center of the first opening 18b and the center of the second opening 13b from the optical axis CL is 5% or greater with respect to the lens pitch, it is determined that the openings are deviated from the optical axis CL of the lens 11.

The louver film 2 illustrated in FIGS. 6 and 7 described above has a configuration in which the centers of all the openings are deviated from the optical axis CL of the lens 11, but the present invention is not limited thereto. For example, which opening to be deviated from the optical axis of the lens may be determined in advance based on the relationship between the openings and the optical axis of the lens according to the direction of directivity and the like.

(Lens)

In the louver film described above, the lens may be a convex cylindrical lens having a semi-cylindrical shape or a hemispherical convex lens. Alternatively, the lens may be an aspheric lens.

The pitch of the plurality of arranged lenses and the size of the curvature radius may be random. In this case, the constant pitch is an average value of the pitches of the plurality of arranged lenses.

In a first embodiment, the pitch of the lenses has a size less than or equal to the thickness of the first support. In a case where a high-refractive index material is used as the first support, from the viewpoint that the brittleness does not deteriorate, it is preferable that the pitch of the lens and the thickness of the first support are set to 30 μm or less so that the first support has a thickness of 30 μm or less, which is thin.

From the viewpoint of the directivity, the refractive index of the lens is preferably smaller than that of the first support and is preferably 1.9 or less. The refractive index thereof is more preferably 1.7 or less.

In the second embodiment, the pitch of the lenses has a size greater than the thickness of the first support. In a case where a high-refractive index material is used as the first support, from the viewpoint that the brittleness does not deteriorate, it is preferable that the pitch of the lens and the thickness of the first support are set to 30 μm or less so that the first support has a thickness of 30 μm or less, which is thin.

The refractive index of the lens is in a range of 1.65 to 1.9 from the viewpoint of the directivity. The refractive index thereof is preferably in a range of 1.65 to 1.75.

(First Support)

In the first embodiment, the thickness of the first support is equal to or larger than the pitch of the lens from the viewpoint of directivity.

Meanwhile, in the second embodiment, the thickness of the first support is smaller than the pitch of the lenses.

In a case where a high-refractive index material is used as the first support, the thickness is preferably 30 μm or less from the viewpoint that the brittleness does not deteriorate. The thickness thereof is more preferably 10 μm or less and more preferably approximately 1 μm.

In the first embodiment, the refractive index of the first support is 1.5 or greater, preferably 1.60 or greater, more preferably 1.65 or greater, and still more preferably 1.80 or greater. In addition, from the viewpoint that the brittleness of the first support layer does not deteriorate, the average refractive index of the high-refractive index layer is preferably 2.50 or less, more preferably 2.20 or less, still more preferably less than 2.10, and even still more preferably 2.05 or less.

In the second aspect, the refractive index of the first support is in a range of 1.4 to 1.65 from the viewpoint of the directivity. The refractive index thereof is preferably in a range of 1.45 to 1.65.

The refractive index can be measured using a known refractive index determination device. As the refractive index measuring device, a multi-wavelength Abbe refractometer DR-M2 (manufactured by Atago co., Ltd.) can be exemplified. Further, the refractive index in the present invention indicates a refractive index with respect to light having a wavelength of 550 nm.

The refractive index of the first support can be adjusted according to the kind of component used for forming a layer. As the component used for forming a layer, a polymerizable composition containing a polymerizable compound and a polymerization initiator can be used for formation. Alternatively, a resin layer containing a resin as a main component may be used. Here, the term “main component” means that the resin occupies the largest part in the components constituting the layer. The layer may contain one or more kinds of resins. The amount of the resin in the resin layer is, for example, 50% by mass or greater and preferably 70% by mass or greater with respect to the total mass of the resin layer. Further, the amount of the resin in the resin layer may be, for example, 99% by mass or less, 95% by mass or less, or 100% by mass with respect to the total mass of the resin layer. Specific examples of the resin layer include a thermoplastic resin layer. Examples of the thermoplastic resin include a polymethyl methacrylate (PMMA) resin, a polycarbonate resin, a polystyrene resin, a polymethacryl styrene (MS) resin, an acrylonitrile styrene (AS) resin, a polypropylene resin, a polyethylene resin, a polyethylene terephthalate resin, a polyvinyl chloride (PVC) resin, cellulose acylate, cellulose triacetate, cellulose acetate propionate, cellulose diacetate, a thermoplastic elastomer, or copolymers thereof, and a cycloolefin polymer. From the viewpoint of easily forming the layer, it is preferable that such a resin layer is a cured layer formed by employing a polymerizable composition and performing a polymerization treatment (curing treatment) on this composition. The polymerizable composition may be a photopolymerizable composition that is cured by irradiation with light or a thermopolymerizable composition that is cured by being heated. From the viewpoint of improving the productivity, a photopolymerizable composition is preferable because the curing treatment can be completed in a short time.

The layer may contain particles in order to adjust the refractive index of the first support. The particles are not particularly limited and may be inorganic particles or organic particles.

Specific examples of the above-described particles include inorganic particles such as ZrO₂, TiO₂, Al₂O₃, In₂O₃, ZnO, SnO₂, and Sb₂O₃; and organic particles such as polymethyl methacrylate particles, cross-linked polymethyl methacrylate particles, acrylic-styrene copolymer particles, melamine particles, polycarbonate particles, polystyrene particles, cross-linked polystyrene particles, polyvinyl chloride particles, and benzoguanamine-melamine formaldehyde particles. Further, as the above-described particles, particles which are subjected to a surface treatment for suppressing the activity of the surface of each particle and improving the dispersibility in the layer so that a coating layer is formed on the surface, so-called core-shell particles may be used. For such particles, for example, paragraphs 0022 to 0025 in JP2013-251066A can be referred to. Further, the above-described particles may be organic-inorganic composite particles such as particles having an organic coated film on the surface of each inorganic particle.

The layer may contain one kind of particles or a mixture of two or more kinds of particles. From the viewpoint of suppressing the scattering property, it is preferable that the size of the particles decreases. Therefore, the particle size as the primary particle diameter is preferably 100 nm or less, more preferably 30 nm or less, and still more preferably 25 nm or less. Further, the particle size as the primary particle diameter is preferably 1 nm or greater. The primary particle diameter of the above-described particles is a value calculated as a number average value obtained by measuring the particle diameters of 50 particles using a scanning electron microscope (SEM). The content of the particles in the layer containing the above-described particles may be appropriately set so as to obtain an average refractive index preferably in the above-described range.

Typically, the dispersibility of the particles in a resin deteriorates as the particle size thereof decreases, but dispersion of the particles can be carried out while the transparency is maintained by grafting fine particles using one-terminal adsorptive resins described in Research Report “Development of Thermoplastic Nanocomposite Optical Materials” (Fujifilm Corporation, Research Report No. 58 (2013)).

From the viewpoint of adjusting the refractive index, the refractive index (the refractive index with respect to light having a wavelength of 550 nm) of the above-described particles is preferably in a range of 2.00 to 3.00 and more preferably in a range of 2.05 to 2.50. Here, the refractive index of the particles is a value measured according to the following method. A resin material having a known refractive index is doped with the particles to prepare a resin material in which the particles have been dispersed. A silicon substrate or a quartz substrate is coated with the prepared resin material to form a resin film. The refractive index of the formed resin film is measured using an ellipsometer, and the refractive index of the particles is acquired from the resin material constituting the resin film and the volume fraction of the particles. The refractive index of the titanium oxide particles used in the examples described later is a value acquired according to the above-described method.

(Light Reflecting Layer)

The light reflecting layer is formed of, for example, white ink, metal foil, metal deposition, or silver mirror ink. The light reflecting layer has a second opening for each lens similarly to the light absorbing layer and has the second opening on the optical axis of each of the plurality of lenses. The light reflecting layer and the light absorbing layer have the same opening pattern. As described above, the light reflecting layer and the light absorbing layer are disposed in a state where the first opening of the light absorbing layer and the second opening of the light reflecting layer are aligned.

In a case where the opening ratio of the second opening is extremely small, the light use efficiency decreases. Meanwhile, in a case where the opening ratio thereof is extremely large, the directivity deteriorates.

In the first aspect, from this viewpoint, the opening ratio of the second opening is preferably in a range of 30% to 70%. The opening ratio thereof is more preferably in a range of 30% to 60%. The opening ratio thereof is still more preferably in a range of 35% to 55%.

Further, in the second aspect, the opening ratio of the second opening is preferably in a range of 10% to 70% and more preferably in a range of 15% to 65%.

From the viewpoint of the light usage rate, the reflectivity is preferably 90% or greater and more preferably 91% or greater. The reflectivity thereof is more preferably 92% or greater. The light usage rate is defined based on a ratio T/T0 between the maximum brightness T0 in a state where the louver film is not disposed and the maximum brightness T in a state where the louver film is disposed.

The reflectivity of the light reflecting layer is obtained as follows. Using a spectrophotometer (V-550, manufactured by JASCO Corporation), a material used for the light reflecting layer is formed on a polyethylene terephthalate (PET) base material, light is incident from the formed surface, and the reflectivity at a wavelength of 380 nm to 780 nm is measured, and the average value thereof is acquired. This average value is the reflectivity of the light reflecting layer.

The second opening of the light reflecting layer may have a pattern according to the disposition of an LED light source used in the direct backlight. That is, the second opening may not be provided directly above the LED light source, and the opening ratio of the second opening may increase as the distance from the LED light source increases. In this case, the diameter of the lens is changed in the plane so that the diameter of the lens and the opening ratio of the second opening with respect to the diameter of the lens are set to be in the above-described preferable ranges. In this manner, an opening can be provided according to light beams from the LED light source, and parallel light can be formed while light is used more efficiently. Further, from the viewpoint of the light usage rate, it is preferable that a reflecting layer with a mirror surface is provided on the back surface of the LED light source because light beams are more easily controlled than a case where a diffusive reflecting layer is provided.

Further, the light reflecting layer may include a cholesteric liquid crystal layer.

The cholesteric liquid crystal layer contains a cholesteric liquid crystalline phase and has a wavelength selective reflection property with respect to circular polarization in one revolving direction (right circular polarization or left circular polarization) in a specific wavelength range.

Therefore, the light reflecting layer can reflect red light, green light, and blue light in a portion other than the second opening by allowing the light reflecting layer to have a configuration including a cholesteric liquid crystal layer that reflects right circular polarization in a red wavelength range (620 nm to 750 nm), a cholesteric liquid crystal layer that reflects left circular polarization in a red wavelength range, a cholesteric liquid crystal layer that reflects right circular polarization in a green wavelength range (495 nm to 570 nm), a cholesteric liquid crystal layer that reflects left circular polarization in the green wavelength range, a cholesteric liquid crystal layer that reflects right circular polarization in a blue wavelength range (420 nm to 490 nm), and a cholesteric liquid crystal layer that reflects left circular polarization in a blue wavelength range according to the configuration of a color filter of a liquid crystal display device described below.

A selective reflection wavelength λ of the cholesteric liquid crystalline phase depends on the pitch P (=helical period) of the helical structure in the cholesteric liquid crystalline phase and follows the relationship between the average refractive index n of the cholesteric liquid crystalline phase and the equation of “λ=n×P”. Therefore, the selective reflection wavelength can be adjusted by adjusting the pitch of the helical structure. Since the pitch of the cholesteric liquid crystalline phase depends on the kind of chiral agent used together with the polymerizable liquid crystal compound or the addition concentration thereof, a desired pitch can be obtained by adjusting these.

Further, a half-width Δλ (nm) of the selective reflection band (circular polarization reflection band) showing selective reflection depends on the refractive index anisotropy Δn of the cholesteric liquid crystalline phase and the pitch P of the helix and follows the relationship of “Δλ=Δn×P”. Therefore, the width of the selective reflection band can be controlled by adjusting the refractive index anisotropy Δn. The refractive index anisotropy Δn can be adjusted based on the kind of the liquid crystal compound forming the cholesteric liquid crystal layer, the mixing ratio thereof, and the temperature at the time of alignment. Further, it is also known that the reflectivity in the cholesteric liquid crystalline phase depends on the refractive index anisotropy Δn. In a case where the same reflectivity is obtained, the number of helical pitches decreases as the refractive index anisotropy Δn increases, that is, the film thickness can be smaller.

As the method of measuring the sense and pitch of the helix, the methods described in “Introduction to Liquid Crystal Chemistry Experiments” (edited by Japanese Liquid Crystal Society, Sigma Publishing Co., Ltd, 2007, p. 46) and “Liquid Crystal Handbook” (Liquid Crystal Handbook Editorial Committee, Maruzen, p. 196) can be used.

The reflected light of the cholesteric liquid crystalline phase is circular polarization. Whether the reflected light is right circular polarization or left circular polarization depends on the helical twist direction of the cholesteric liquid crystalline phase. In the selective reflection of circular polarization by the cholesteric liquid crystalline phase, right circular polarization is reflected in a case where the helical twist direction of the cholesteric liquid crystalline phase is right, and left circular polarization is reflected in a case where the helical twist direction is left.

Further, the revolving direction of the cholesteric liquid crystalline phase can be adjusted according to the kind of the liquid crystal compound forming the reflective region or the kind of the chiral agent to be added.

The selective reflection wavelength in the cholesteric liquid crystal layer can also be set in any range of visible light (approximately 380 to 780 nm) and near-infrared light (approximately 780 to 2000 nm), and the setting method is as described above.

Examples of the material used for forming the cholesteric liquid crystal layer include a liquid crystal composition that contains a liquid crystal compound. It is preferable that the liquid crystal compound is a polymerizable liquid crystal compound.

The liquid crystal composition containing a polymerizable liquid crystal compound may further contain a surfactant, a chiral agent, a polymerization initiator, and the like. As the liquid crystal compound, the surfactant, the chiral agent, and the polymerization initiator, known liquid crystal compounds, surfactants, chiral agents, and polymerization initiators used for a cholesteric liquid crystal layer can be used.

Here, in a case where the light reflecting layer includes a cholesteric liquid crystal layer, the second opening may be physically formed. Further, as the second opening, a region having a light-transmitting property may be formed in the region which becomes the second opening without forming a cholesteric liquid crystalline phase in the region and by allowing the region not to have a reflection property.

Further, the light reflecting layer may be prepared using a photoresist method. The opposite surface of the lens is coated with a resist material, irradiated with light through a mask according to a pattern of the reflecting layer intended to be prepared, and developed. Thereafter, the reflecting layer having a desired pattern can be prepared by performing deposition of aluminum or silver and washing and removing the resist material. In a case where a photomask is not used, parallel light can be applied from a side of the lens in place of the photomask. The method of applying parallel light from a side of the lens is better than the case of using a photomask in terms that the aligning accuracy between the lens and the opening can be improved.

At this time, examples of light used for exposure includes ultraviolet rays such as g-line, h-line, i-line, and j-line. Among these, exposure to i-line is particularly preferable.

The film can be dried (pre-bake) with the photoresist material provided (preferably applied) onto the substrate under conditions of a temperature range of 50° C. to 140° C. for 10 to 300 seconds using a hot plate, an oven, or the like.

In the development, the uncured portion after the exposure is eluted into the developer, and only the cured portion is allowed to remain. The development temperature is typically in a range of 20° C. to 30° C., and the development time is in a range of 20 to 600 seconds. Any developer can be used as long as the developer dissolves the film of the photosensitive resin composition in the uncured portion and does not dissolve the cured portion. Specifically, a combination of various organic solvents or an alkaline aqueous solution can be used.

Examples of the above-described organic solvent include those listed as the above-described solvents that can be used at the time of preparing the photosensitive resin composition.

Examples of the alkaline aqueous solution include alkaline aqueous solutions obtained by dissolving alkaline compounds such as sodium hydroxide, potassium hydroxide, sodium carbonate, sodium hydrogen carbonate, sodium silicate, sodium metasilicate, aqueous ammonia, ethylamine, diethylamine, dimethylethanolamine, tetramethylammonium hydroxide, tetraethylammonium hydroxide (TMAH), choline, pyrrole, piperidine, and 1,8-diazabicyclo-[5,4,0]-7-undecene at a concentration of 0.001% to 10% by mass and preferably 0.01% to 1% by mass.

Further, in a case where an alkaline aqueous solution is used as a developer, washing (rinsing) with water is typically performed after development.

The photoresist material is formed to contain a photopolymerization initiator (A), a solvent (B), a polymerizable monomer (C), and an alkali-soluble resin (D), the photopolymerization initiator (A) contains one or more o-acyl oxime ester compounds and one or more α-aminoacetophenone compounds, and two or more independent patterns can be formed at the same time. At least one of the alkali-soluble resins (D) has an acid value of 150 to 400 mgKOH/g. Further, the photoresist material further contains a photosensitizer or co-initiator (E).

The total amount of the photopolymerization initiator (A) and the photosensitizer or co-initiator (E) to be added is in a range of 0.1% to 15.0% by weight with respect to the total solid content in the photosensitive resin composition. The polymerizable monomer (C) contains an acid group, and the acid value is in a range of 20 to 150 mgKOH/g. The o-acyl oxime ester compound has an aromatic ring. The o-acyl oxime ester compound has a fused ring having an aromatic ring. The o-acyl oxime ester compound has a fused ring having a benzene ring and a hetero ring. The photoresist material contains the o-acyl oxime ester compound and the α-aminoacetophenone compound at a ratio of 10:90 to 80:20 (weight ratio). The alkali-soluble resin (D) is an acrylic resin.

The photosensitive resin composition of the present invention contains a photopolymerization initiator (A), a solvent (B), a polymerizable monomer (C), and an alkali-soluble resin (D), the photopolymerization initiator (A) contains one or more o-acyl oxime ester compounds and one or more α-aminoacetophenone compounds, and two or more independent patterns can be formed at the same time. By using the o-acyl oxime ester compound and the α-aminoacetophenone compound in combination, two or more independent patterns can be formed.

Here, “two or more kinds of independent patterns can be formed at the same time” means that two or more kinds of patterns having different heights are formed by one exposure. One exposure means exposure performed at the same time. The exposure method as the exposure performed at the same time is not limited, and examples thereof include a method of using halftone masks having different transmittances and a method of performing exposure by applying light with two or more exposure amounts at the same time.

The two or more kinds of patterns having different heights indicate that, for example, in a case of two kinds of patterns, a pattern group (1) consisting of a plurality of high-height patterns and a pattern group (2) consisting of a plurality of low-height patterns are present. Further, a difference in height between the pattern group (1) and the pattern group (2) is preferably in a range of 0.4 to 1.1 pun. The heights of the pattern groups can be respectively determined as an average value thereof. Further, it is preferable that the height of each independent pattern group is constant, and the standard deviation 3a is preferably ±0.1 μm.

Hereinafter, each component of the present invention will be described in detail.

Photopolymerization Initiator (A)

In the present invention, an o-acyl oxime ester compound and an α-aminoacetophenone compound are used as the photopolymerization initiator (A).

O-Acyl Oxime Ester Compound

The o-acyl oxime ester compound used in the present invention is not particularly limited as long as the compound has a —C═N—O—C(═O) structure, but a compound having an aromatic ring is preferable, a compound having a fused ring that has an aromatic ring is more preferable, and a compound having a fused ring having a benzene ring and a hetero ring is still more preferable. Further, it is preferable that the o-acyl oxime ester compound used in the present invention has a structure in which an oxime ester group is directly bonded to the above-described fused ring. Here, the fused ring having an aromatic ring may be any fused ring as long as at least one ring is an aromatic ring.

The o-acyl oxime ester compound can be appropriately selected from known photopolymerization initiators such as o-acyl oxime ester compounds described in JP2000-080068A and JP2001-233842A. Specific examples thereof include 1-(4-phenylsulfanyl-phenyl)-butane-1,2-dione 2-oxime-o-benzoate, 1-(4-phenylsulfanyl-phenyl)-octane-1,2-dione 2-oxime-o-benzoate, 1-(4-phenylsulfanyl-phenyl)-octane-1-one oxime-o-acetate, and 1-(4-phenylsulfanyl-phenyl)-butane-1-one oxime-o-acctate. The o-acyl oxime ester compound may be used alone or in combination of two or more kinds thereof.

Further, IRGACURE OXE01 or IRGACURE OXE02 (manufactured by BASF SE) can also be used as the oxime ester-based photopolymer.

α-Aminoacetophenone Compound

The α-aminoacetophenone compound may be used alone or in combination of two or more kinds thereof.

Further, as the α-aminoacetophenone compound, an acid adduct salt of the compound represented by Formula (4) can be used.

Further, examples of commercially available α-aminoacetophenone compounds include available polymerization initiators such as IRGACURE 907, IRGACURE 369, and IRGACURE 379 (all trade names, manufactured by Ciba Specialty Chemicals Inc.).

Specific examples of the α-aminoacetophenone compound include 2-dimethylamino-2-methyl-1-phenylpropan-1-one, 2-diethylamino-2-methyl-1-phenylpropan-1-one, 2-methyl-2-morpholino-1-phenylpropan-1-one, 2-dimethylamino-2-methyl-1-(4-methylphenyl)propan-1-one, 2-dimethylamino-1-(4-ethylphenyl)-2-methylpropan-1-one, 2-dimethylamino-1-(4-isopropylphenyl)-2-methylpropan-1-one, 1-(4-butylphenyl)-2-dimethylamino-2-methylpropan-1-one, 2-dimethylamino-1-(4-methoxyphenyl)-2-methylpropan-1-one, 2-dimethylamino-2-methyl-1-(4-methylthiophenyl)propan-1-one, 2-methyl-1-(4-methylthiophenyl)-2-morpholinopropan-1-one (IRGACURE 907), 2-benzyl-2-dimethylamino-1-(4-morpholinophenyl)-butan-1-one (IRGACURE 369), 2-benzyl-2-dimethylamino-1-(4-dimethylaminophenyl)-butan-1-one, and 2-dimethylamino-2-[(4-methylphenyl)methyl]-1-[4-(4-morpholinyl)phenyl]-1-butanone (IRGACURE 379).

The content of the α-aminoacetophenone compound is preferably in a range of 0.1% to 10% by mass, more preferably in a range of 0.3% to 8% by mass, and still more preferably in a range of 0.5% to 5% by mass with respect to the total solid content of the photosensitive resin composition of the present invention from which solvents have been removed.

Other Photopolymerization Initiators

In the present invention, other generally known photopolymerization initiators can be further used in combination within a range where the effect of the combination of the o-acyl oxime ester compound and the α-aminoacetophenone compound is not impaired. The photopolymerization initiator that can be used in combination is not particularly limited, but the weight of the o-acyl oxime ester compound and the α-aminoacetophenone compound is preferably 80% or greater from the viewpoints of the halftone suitability and sensitivity and more preferably 90% or greater with respect to the total weight of the photoinitiator. Even in a case where other initiators are used in combination, the optimum addition weight ratio of the o-acyl oxime ester compound and the α-aminoacetophenone compound is the same as described above.

Solvent (B)

The solvent (B) that can be used in the present invention is not particularly limited within a range not departing from the scope of the present invention, and examples thereof include solvents classified into esters, ethers, ketones, and aromatic hydrocarbons.

Examples of the esters used as the solvent (B) include ethyl acetate, n-butyl acetate, isobutyl acetate, amyl formate, isoamyl acetate, isobutyl acetate, butyl propionate, isopropyl butyrate, ethyl butyrate, butyl butyrate, alkyl esters, methyl lactate, ethyl lactate, methyl oxyacetate, ethyl oxyacetate, butyl oxyacetate, methyl methoxyacetate, ethyl methoxyacetate, butyl methoxyacetate, methyl ethoxyacetate, and ethyl ethoxyacetate, and 3-oxypropionic acid alkyl esters such as methyl 3-oxypropionate and ethyl 3-oxypropionate; 2-oxypropionic acid alkyl esters such as methyl 2-oxypropionate, ethyl 2-oxypropionate, propyl 2-oxypropionate, methyl 2-oxy-2-methylpropionate, and ethyl 2-oxy-2-methylpropionate; alkoxypropionic acid alkyl ester such as methyl 3-methoxypropionate, ethyl 3-methoxypropionate, methyl 3-ethoxypropionate, ethyl 3-ethoxypropionate, methyl 2-methoxypropionate, ethyl 2-methoxypropionate, propyl 2-methoxypropionate, methyl 2-ethoxypropionate, ethyl 2-ethoxypropionate, methyl 2-methoxy-2-methylpropionate, or ethyl 2-ethoxy-2-methylpropionate; and methyl pyruvate, ethyl pyruvate, propyl pyruvate, methyl acetoacetate, ethyl acetoacetate, methyl 2-oxobutanoate, ethyl 2-oxobutanoate.

Examples of the ethers include diethylene glycol dimethyl ether, tetrahydrofuran, ethylene glycol monomethyl ether, ethylene glycol monoethyl ether, methyl cellosolve acetate, ethyl cellosolve acetate, diethylene glycol monomethyl ether, diethylene glycol monoethyl ether, diethylene glycol monobutyl ether, propylene glycol methyl ether acetate, propylene glycol ethyl ether acetate, and propylene glycol propyl ether acetate.

Examples of the ketones include methyl ethyl ketone, cyclohexanone, 2-heptanone, and 3-heptanone.

Examples of the aromatic hydrocarbons include toluene and xylene.

Among these solvents, methyl 3-ethoxypropionate, ethyl 3-ethoxypropionate, ethyl cellosolve acetate, ethyl lactate, diethylene glycol dimethyl ether, butyl acetate, methyl 3-methoxypropionate, 2-heptanone, cyclohexanone, ethyl carbitol acetate, butyl carbitol acetate, and propylene glycol methyl ether acetate are preferable.

The solvents may be used alone or in combination of two or more kinds thereof.

The content of the solvent (B) in the photosensitive resin composition of the present invention is appropriately determined in consideration of the coating property of the photosensitive resin composition, and the content of the solvent (B) is typically in a range of 45% to 85% by mass.

Polymerizable Monomer (C)

The photosensitive resin composition of the present invention contains at least one polymerizable monomer (C) as a curable component. As the polymerizable monomer, a plurality of polymerizable monomers may be used in combination, and one or more kinds of polymerizable monomers containing an acid group and one or more kinds of polymerizable monomers that do not contain an acid group may be used in combination.

Examples of the polymerizable monomer containing a carboxyl group include unsaturated fatty acids such as acrylic acid, methacrylic acid, phthalic acid, fumaric acid, maleic acid, itaconic acid, crotonic acid, and cinnamonic acid, and a carboxyl group-modified polyfunctional acrylate compound. Examples of the carboxyl-modified polyfunctional acrylate compound include succinic acid-modified pentaerythritol triacrylate, succinic acid-modified trimethylolpropane triacrylate, succinic acid-modified pentaerythritol tetraacrylate, succinic acid-modified dipentaerythritol pentaacrylate, succinic acid-modified dipenta erythritol hexaacrylate, adipic acid-modified pentaerythritol triacrylate, adipic acid-modified trimethylolpropane triacrylate, adipic acid-modified pentaerythritol tetraacrylate, adipic acid-modified dipentaerythritol pentaacrylate, and adipic acid-modified dipentaerythritol tetraacrylate. Further, commercially available compounds such as ARONIX M-510, ARONIX M-520, ARONIX T-2349, and ARONIX TO-2359 (manufactured by Toagosei Co., Ltd.) can be suitably used.

Examples of the polymerizable monomer containing a phenolic hydroxyl group include p-hydroxystyrene, 3,4-dihydroxystyrene, 3,5-dihydroxystyrene, 2,4,6-trihydroxystyrene, (p-hydroxy) benzyl acrylate, salicylic acid-modified pentaerythritol triacrylate, salicylic acid-modified trimethylolpropane triacrylate, salicylic acid-modified pentaerythritol tetraacrylate, salicylic acid-modified dipentaerythritol pentaacrylate, and salicylic acid-modified dipentaerythritol hexaacrylate. Among these, salicylic acid-modified dipentaerythritol hexaacrylate and salicylic acid-modified dipentaerythritol pentaacrylate are preferable.

Examples of the polymerizable monomer containing a sulfonic acid group include vinyl sulfonic acid, allyl sulfonic acid, styrene sulfonic acid, and butyl sulfonic acid-modified acrylamide. Examples of the polymerizable monomer containing a phosphoric acid group include vinyl phosphoric acid, styrene phosphoric acid, and butyl phosphoric acid-modified acrylamide. Among these, butyl sulfonic acid-modified acrylamide is preferable, and ATBS (manufactured by Toagosei Co., Ltd.) is an example of the commercially available compound.

Among these polymerizable monomers containing these acid groups, from the viewpoints of the manufacturing suitability and the cost, a polymerizable monomer containing a carboxyl group or a polymerizable monomer containing a phenolic hydroxyl group is preferable, and a polymerizable monomer containing a carboxyl group is more preferable.

(Polymerizable Monomer that does not Contain Acid Group)

The polymerizable monomer that does not contain an acid group which can be used in combination with the polymerizable monomer containing an acid group in the present invention is not particularly limited as long as the monomer is polymerizable, and suitable examples thereof include a low-molecular-weight compound having at least one ethylenic double bond and an addition-polymerizable compound such as a dimer, a trimer, or an oligomer.

Examples of the ethylenic compound include an ester of an unsaturated carboxylic acid and a monohydroxy compound, an ester of an aliphatic polyhydroxy compound and an unsaturated carboxylic acid, an ester of an aromatic polyhydroxy compound and an unsaturated carboxylic acid, an ester obtained by an esterification reaction of an unsaturated carboxylic acid and a polycarboxylic acid with a polyvalent hydroxy compound such as the fatty acid polyhydroxy compound or aromatic polyhydroxy compound described above, and an ethylenic compound having a urethane skeleton obtained by reacting a polyisocyanate compound with a (meth)acryloyl-containing hydroxy compound.

Specific polymerizable monomers can be classified according to the number of polymerizable groups in one molecule as described below, but the present invention is not limited thereto.

(1) Compound having one polymerizable group in one molecule Examples of the compound having one polymerizable group in one molecule include hexyl (meth)acrylate, 2-ethylhexyl (meth)acrylate, stearyl (meth)acrylate, cyclohexyl (meth)acrylate, 4-n-butylcyclohexyl (meth)acrylate, bomyl (meth)acrylate, isobornyl (meth)acrylate, benzyl (meth)acrylate, 2-ethylhexyl diglycol (meth)acrylate, butoxyethyl (meth)acrylate, 2-chloroethyl (meth)acrylate, cyanoethyl (meth)acrylate, 3-methoxybutyl (meth)acrylate, 2-(2-methoxyethoxy) ethyl (meth)acrylate, 2,2,2-tetrafluoroethyl (meth)acrylate, 1H,1H,2H,2H perfluorodecyl (meth)acrylate, phenyl (meth)acrylate, 2,4,5-tetramethylphenyl (meth)acrylate, 4-chlorophenyl (meth)acrylate, phenoxymethyl (meth)acrylate, glycidyl (meth)acrylate, glycidyloxybutyl (meth)acrylate, glycidyloxyethyl (meth)acrylate, 2-hydroxyethyl (meth)acrylate, 3-hydroxypropyl (meth)acrylate, 2-hydroxypropyl (meth)acrylate, 2-hydroxybutyl (meth)acrylate, 4-hydroxybutyl (meth)acrylate, 3-hydroxypropyl (meth)acrylate, polyethylene oxide monomethyl ether (meth)acrylate, oligoethylene oxide methyl ether (meth)acrylate, polyethylene oxide (meth)acrylate, oligoethylene oxide (meth)acrylate, 2-hydroxy-3-phenoxypropyl (meth)acrylate, EO-modified phenol (meth)acrylate, EO-modified cresol (meth)acrylate, EO-modified nonylphenol (meth)acrylate, PO-modified nonylphenol (meth)acrylate, and EO-modified-2-ethylhexyl (meth)acrylate.

(2) Compound Containing Two Polymerizable Groups in One Molecule

Examples of the compound containing two polymerizable groups in one molecule include a compound containing two (meth)acryloyl groups in the same molecule as the polymerizable group, and examples thereof include ethylene glycol di(meth)acrylate, diethylene glycol di(meth)acrylate, triethylene glycol di(meth)acrylate, polyethylene glycol di(meth)acrylate, 1,3-butylene glycol di(meth)acrylate, 1,4-butanediol di(meth)acrylate, 1,6-hexanediol di(meth)acrylate, neopentyl glycol di(meth)acrylate, propylene glycol di(meth)acrylate, dipropylene glycol di(meth)acrylate, tripropylene glycol di(meth)acrylate, polypropylene glycol di(meth)acrylate, 2-hydroxy-1,3-diacryloxypropane, 2,2-bis [4-(acryloxyethoxy)phenyl]propane, 2,2-bis[4-(acryloxydiethoxy)phenyl]propane, bis(acryloyloxyethyl) ether of bisphenol A, a (meth)acrylic acid-modified product of a bisphenol A type epoxy resin, 3-methylpentanediol di(meth)acrylate, 2-hydroxy-3-acryloyloxy propyl methacrylate, and dimethylol-tricyclodecane di(meth)acrylate. Among these, dimethylol-tricyclodecane di(meth)acrylate, neopentyl glycol di(meth)acrylate, ethoxylated bisphenol A di(meth)acrylate, and a (meth)acrylic acid-modified product of a bisphenol A type epoxy resin are preferable.

(3) Compound containing three polymerizable groups in one molecule Examples of the compound containing three polymerizable groups in one molecule include trimethylolpropane tri(meth)acrylate, trimethylolethane tri(meth)acrylate, alkylene oxide-modified tri(meth)acrylate of trimethylolpropane, pentaerythritol tri(meth)acrylate, dipentaerythritol tri(meth)acrylate, trimethylolpropane tri((meth)acryloyloxypropyl) ether, isocyanuric acid alkylene oxide-modified tri(meth)acrylate, propionic acid dipentaerythritol tri(meth)acrylate, tri((meth)acryloyloxyethyl) isocyanurate, hydroxypivalaldehyde-modified dimethylolpropane tri(meth)acrylate, sorbitol tri(meth)acrylate, propoxylated trimethylolpropane tri(meth)acrylate, and ethoxylated glycerin triacrylate.

(4) Compound containing four or more polymerizable groups in one molecule Examples of the compound containing four or more polymerizable groups in one molecule include pentaerythritol tetra(meth)acrylate, sorbitol tetra(meth)acrylate, ditrimethylolpropane tetra(meth)acrylate, propionic acid dipentaerythritol tetra(meth)acrylate, ethoxylated pentaerythritol tetra(meth)acrylate, dipentaerythritol penta(meth)acrylate, dipentaerythritol hexa(meth)acrylate, sorbitol penta(meth)acrylate, sorbitol hexa(meth)acrylate, alkylene oxide-modified hexa(meth)acrylate of phosphazene, captolactone-modified dipentaerythritol hexa(meth)acrylate, and urethane acrylate such as UA-306H, UA-306T, or UA-3061 (all manufactured by Kyoeisha Chemical Co., Ltd.).

Among these, from the viewpoints of suitably maintaining the solvent resistance and indium tin oxide (ITO) sputtering suitability, a (meth)acrylate monomer containing two or more (meth)acryloyl groups in the same molecule is preferable, and a (meth)acrylate monomer containing three or more (meth)acryloyl groups is more preferable.

In particular, a (meth)acrylate monomer containing four or more (meth)acryloyl groups is advantageous. For example, dipentaerythritol pentaacrylate and dipentaerythritol hexaacrylate are preferable from the viewpoints of the solvent resistance and ITO sputtering suitability, and a mixture thereof (a mixture ratio of dipentaerythritol pentaacrylate:dipentaerythritol hexaacrylate=2 to 4:8 to 6 in terms of mass) is suitably used.

In a case where a polymerizable monomer containing an acid group and a polymerizable monomer that does not contain an acid group are used in combination, the preferable addition ratio at the time of setting the total amount of the polymerizable monomer containing an acid group and the polymerizable monomer that does not contain an acid group to 100 parts by mass is not particularly limited as long as the acid value is in the above-described preferable range.

The content of the polymerizable monomer in the photosensitive resin composition of the present invention is preferably in a range of 5% to 80% by mass, more preferably in a range of 10% to 70% by mass, and still more preferably in a range of 20% to 60% by mass with respect to the total solid content in the photosensitive resin composition from which solvents have been removed.

Alkali-Soluble Resin (D)

As the alkali-soluble resin (D) which can be applied to the present invention, any polymer compound soluble in a solvent can be used. In each alkali-soluble resin, a single compound or a combination of a plurality of compounds may be used. As the alkali-soluble resin, a resin containing an acid group (hereinafter, appropriately referred to as an “alkali-soluble resin”) is preferable in consideration of alkali developability according to a photolithographic method.

The alkali-soluble resin is a linear organic high-molecular-weight polymer. Among the examples, an alkali-soluble polymer containing at least one alkali-soluble group (for example, a carboxyl group, a phosphoric acid group, or a sulfonic acid group) is preferable, and a compound which is soluble in an organic solvent and can be developed with a weak alkaline aqueous solution is more preferable.

For example, a method based on a known radical polymerization method can be applied to production of the alkali-soluble resin.

The polymerization conditions such as the temperature, the pressure, the kind and amount of the radical initiator, and the kind of the solvent for production of the alkali-soluble resin according to a radical polymerization method can be easily set by those skilled in the art, and the conditions can be experimentally determined.

As the linear organic high-molecular-weight polymer applied as the alkali-soluble resin, a polymer containing a carboxyl group in a side chain is preferable.

Examples thereof include a methacrylic acid copolymer, an acrylic acid copolymer, an itaconic acid copolymer, a crotonic acid copolymer, a maleic acid copolymer, a partially esterified maleic acid copolymer, an acidic cellulose derivative having a carboxylic acid in a side chain, and a polymer obtained by adding an acid anhydride to a polymer containing a hydroxyl group as described in JP1984-044615A (JP-S-59-044615A), JP1979-034327B (JP-S54-034327B), JP1983-012577B (JP-S58-012577B), JP1979-025957B (JP-S54-025957B), JP1984-053836A (JP-S59-053836A), and JP1984-071048A (JP-S59-071058A). Among these, a high-molecular-weight polymer further containing a (meth)acryloyl group in a side chain is preferable.

Among these, a multi-component copolymer formed of a benzyl (meth)acrylate/(meth)acrylic acid copolymer or a benzyl (meth)acrylate/(meth)acrylic acid/another monomer is particularly suitable. In addition, those obtained by copolymerizing 2-hydroxyethyl methacrylate are also useful.

The above-described polymers can be used in mixture in any amount.

In addition to the above-described examples, other examples thereof include a 2-hydroxypropyl (meth)acrylate/polystyrene macromonomer/benzyl methacrylate/methacrylic acid copolymer, a 2-hydroxy-3-phenoxypropyl acrylate/polymethyl methacrylate macromonomer/benzyl methacrylate/methacrylic acid copolymer, a 2-hydroxyethyl methacrylate/polystyrene macromonomer/methyl methacrylate/methacrylic acid copolymer, and a 2-hydroxyethyl methacrylate/polystyrene macromonomer/benzyl methacrylate/methacrylic acid copolymer described in JP1995-140654A (JP-H07-140654A).

As other alkali-soluble resins, known polymer compounds described in JP1995-207211A (JP-H07-207211A), JP1996-259876A (JP-H08-259876A), JP1998-300922A (JP-H10-300922A), JP1999-140114A (JP-HI 1-140144A), JP1999-174224A (JP-H11-174224A), JP2000-056118A, JP2003-233179A, and JP2009-052020A can be used.

As for specific constitutional units of the alkali-soluble resin, particularly, copolymers of (meth)acrylic acid and other monomers which can be copolymerized with the (meth)acrylic acid are suitably used because these are available and the alkali solubility or the like is easily adjusted.

Examples of other monomers which can be copolymerized with the (meth)acrylic acid include alkyl (meth)acrylate, aryl (meth)acrylate, and a vinyl compound. Here, hydrogen atoms of the alkyl group and the aryl group may be substituted with substituents.

Specific examples of the above-described alkyl (meth)acrylate and aryl (meth)acrylate include methyl (meth)acrylate, ethyl (meth)acrylate, propyl (meth)acrylate, butyl (meth)acrylate, isobutyl (meth)acrylate, pentyl (meth)acrylate, hexyl (meth)acrylate, octyl (meth)acrylate, phenyl (meth)acrylate, benzyl acrylate, tolyl acrylate, naphthyl acrylate, and cyclohexyl acrylate.

Examples of the above-described vinyl compound include styrene, α-methylstyrene, vinyltoluene, glycidyl (meth)acrylate, acrylonitrile, vinyl acetate, N-vinylpyrrolidone, tetrahydrofiurnfuryl (meth)acrylate, a polystyrene macromonomer, a polymethyl methacrylate macromonomer, CH₂═CR³¹R³² [here, R³¹ represents a hydrogen atom or an alkyl group having 1 to 5 carbon atoms, and R³² represents an aromatic hydrocarbon ring having 6 to 10 carbon atoms], and CH₂═C(R³¹)(COOR³³) [here, R³¹ represents a hydrogen atom or an alkyl group having 1 to 5 carbon atoms, and R³³ represents an alkyl group having 1 to 8 carbon atoms or an aralkyl group having 6 to 12 carbon atoms].

These other copolymerizable monomers can be used alone or in combination of two or more kinds thereof.

As other copolymerizable monomers, at least one selected from CH₂═CR³¹R³², CH₂═C(R³¹)(COOR³), phenyl (meth)acrylate, benzyl (meth)acrylate, and styrene is preferable, and CH₂═CR³¹R³² and/or CH₂═C(R³¹)(COOR³³) is particularly preferable. R³¹, R³², and R³³ each have the same definition as described above.

Further, the content of the alkali-soluble resin in the photosensitive resin composition is preferably in a range of 5% to 60% by mass, more preferably in a range of 10% to 55% by mass, and particularly preferably in a range of 15% to 50% by mass with respect to the total solid content in the photosensitive resin composition from which solvents have been removed. The weight-average molecular weight (Mw) of the alkali-soluble resin used in the present invention is preferably in a range of 1000 to 100000 and more preferably in a range of 5000 to 50000.

The acid value of the alkali-soluble resin used in the present invention is preferably in a range of 150 to 400 mgKOH/g, more preferably in a range of 180 to 380 mgKOH/g, and still more preferably in a range of 200 to 350 mgKOH/g. In a case where the acid value is in the above-described range, a photosensitive composition with excellent halftone suitability and the like is obtained.

Photosensitizer or Co-Initiator (E)

A photosensitizer or co-initiator (E) may be further added to the photosensitive resin composition of the present invention. The photopolymerization of the photosensitive resin composition of the present invention can be promoted by adding these thereto so that the spectral sensitivity is moved or expanded.

As the above-described photosensitizer or co-initiator, it is particularly preferable to use an aromatic compound, and examples thereof include benzophenone and derivatives thereof, thioxanthone and derivatives thereof, anthraquinone and derivatives thereof, coumarin or phenothiazine and derivatives thereof, 3-(aroylmethylene) thiazoline, rhodanine, camiphorquinone, eosin, rhodamine, erythrosine, xanthene, thioxanthene, acridine (for example, 9-phenylacridine), 1,7-bis(9-acridinyl) heptane, 1,5-bis(9-acridinyl) pentane, cyanine, and a merocyanine dye.

Examples of the above-described thioxanthone include thioxanthone, 2-isopropyithioxanthone, 2-chlorothioxanthone, 1-chloro-4-propoxythioxanthone, 2-dodecyithioxanthone, 2,4-diethylthioxanthone, 2,4-dimethyithioxanthone, 1-methoxycarbonylthioxanthone, 2-ethoxycarbonyithioxanthone, 3-(2-methoxyethoxycarbonyl) thioxanthone, 4-butoxycarbonylthioxanthone, 3-butoxycarbonyl-7-mnethylthioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxycarbonyl-3-phenyl sulfuryl thioxanthone, 3,4-di-[2-(2-methoxyethoxy)ethoxycarbonyl]thioxanthone, 1,3-dimethyl-2-hydroxy-9H-thioxanthene-9-one, 2-ethylhexyl ether, 1-ethoxycarbonyl-3-(1-methyl-1-morpholinoethyl) thioxanthone, 2-methyl-6-dimethoxymethylthioxanthone, 2-methyl-6-(1,1-dimethoxybenzyl) thioxanthone, 2-morpholinomethylthioxanthone, 2-methyl-6-morpholinomethylthioxanthone, N-allylthioxanthone-3,4-dicarboximide, N-octylthioxanthone-3,4-dicarboximide, N-(1,1,3,3-tetramethylbutyl) thioxanthone-3,4-dicarboximide, 1-phenoxythioxanthone, 6-ethoxycarbonyl-2-methoxythioxanthone, 6-ethoxycarbonyl-2-mnethylthioxanthone, thioxanthone-2-carboxylic acid polyethylene glycol ester, and 2-hydroxy-3-(3,4-dimethyl-9-oxo-9H-thioxanthone-2-yloxy)-N,N,N-trimethyl-1-propanaminium chloride.

Examples of the above-described benzophenone include benzophenone, 4-phenylbenzophenone, 4-methoxybenzophenone, 4,4′-dimethoxybenzophenone, 4,4′-dimethylbenzophenone, 4,4′-dichlorobenzophenone, 4,4′-bis(dimethylamino) benzophenone, 4,4′-bis(diethylamino) benzophenone, 4,4′-bis(methylethylamino) benzophenone, 4,4′-bis(p-isopropylphenoxy) benzophenone, 4-methylbenzophenone, 2,4,6-trimethylbenzophenone, 4-(4-methylthiophenyl) benzophenone, 3,3′-dimethyl-4-methoxybenzophenone, methyl-2-benzoylbenzoate, 4-(2-hydroxyethylthio) benzophenone, 4-(4-tolylthio) benzophenone, 1-[4-(4-benzoylphenylsulfanyl phenyl]-2-methyl-2-(toluene-4-sulfonyl)propan-1-one, 4-benzoyl-N,N,N-trimethylbenzene methanaminium chloride, a 2-hydroxy-3-(4-benzoylphenoxy)-N,N,N-trimethyl-1-propanaminium chloride monohydrate, 4-(13-acryloyl-1,4,7,10,13-pentaoxatridecyl) benzophenone, and 4-benzoyl-N,N-dimethyl-N-[2-(l-oxo-2-propenyl) oxy]ethylbenzenemethanaminium chloride.

Examples of the above-described coumarin include Coumarin 1, Coumarin 2, Coumarin 6, Coumarin 7, Coumarin 30, Coumarin 102, Coumarin 106, Coumarin 138, Coumarin 152, Coumarin 153, Coumarin 307, Coumarin 314, Coumarin 314T, Coumarin 334, Coumarin 337, Coumarin 500, 3-benzoyl coumarin, 3-benzoyl-7-methoxycoumarin, 3-benzoyl-5,7-dimethoxycoumarin, 3-benzoyl-5,7-dipropoxycoumarin, 3-benzoyl-6,8-dichlorocoumarin, 3-benzoyl-6-chlorocoumarin, 3,3′-carbonyl-bis [5,7-di(propoxy) coumarin], 3,3′-carbonyl-bis(7-diethylaminocoumarin), 3-isobutyroyl coumarin, 3-benzoyl-5,7-dimethoxycoumarin, 3-benzoyl-5,7-diethoxycoumarin, 3-benzoyl-5,7-dibutoxycoumarin, 3-benzoyl-5,7-di(methoxyethoxy) coumarin, 3-benzoyl-5,7-di(allyloxy) coumarin, 3-benzoyl-7-dimethylaminocoumarin, 3-benzoyl-7-diethylaminocoumarin, 3-isobutyroyl-7-dimethylaminocoumarin, 5,7-dimethoxy-3-(1-naphthoyl) coumarin, 5,7-diethoxy-3-(1-naphthoyl) coumarin, 3-benzoylbenzo [f] coumarin, 7-diethylamino-3-thienoylcoumarin, 3-(4-cyanobenzoyl)-5,7-dimethoxycoumarin, 3-(4-cyanobenzoyl)-5,7-dipropoxycoumarin, 7-dimethylamino-3-phenylcoumarin, and 7-diethylamino-3-phenylcoumarin, and coumarin derivatives disclosed in JP1997-179299A (JP-H09-179299A) and JP1997-325209 (JP-H09-325209A), for example, 7-[{4-chloro-6-(diethylamino)-S-triazin-2-yl}amino]-3-phenylcoumarin.

Examples of the above-described 3-(aroylmethylene) thiazoline include 3-methyl-2-benzoylmethylene-3-naphthothiazoline, 3-methyl-2-benzoylmethylene-benzothiazoline, and 3-ethyl-2-propionylmethylene-naphthothiazoline.

Examples of the above-described rhodanine include 4-dimethylaminobenzalrhodanine, 4-diethylaminobenzalrhodanine, and 3-ethyl-5-(3-octyl-2-benzothiazolinylidene) rhodanine, and rhodanine derivatives represented by Formulae [1], [2], and [7] disclosed in JP-1996-305019 (JP-H08-305019A).

In addition to the above-described compounds, other examples thereof include acetophenone, 3-methoxyacetophenone, 4-phenylacetophenone, benzyl, 4,4′-bis(dimethylamino) benzyl, 2-acetylnaphthalene, 2-naphthaldehyde, dansyl acid derivatives, 9,10-anthraquinone, anthracene, pyrene, aminopyrene, perylene, phenanthrene, phenanthrenequinone, 9-fluorenone, dibenzosuberone, curcumin, xanthone, thiomichler ketone, α-(4-dimethylaminobenzylidene) ketone, 2,5-bis(4-diethylaminobenzylidenecyclopentanone, 2-(4-dimethylaminobenzylidene) indan-1-one, 3-(4-dimethylaminophenyl)-1-indan-5-ylpropenone, 3-phenylthiophthalimide, N-methyl-3,5-di(ethylthio) phthalimide, N-methyl-3,5-di(ethylthio) phthalimide, phenothiazine, methylphenothiazine, amine, N-phenylglycine, ethyl 4-dimethylaminobenzoate, butoxyethyl 4-dimethylaminobenzoate, 4-dimethylaminoacetophenone, triethanolamine, methyldiethanolamine, dimethylaminoethanol, and 2-(dimethylamino) ethylbenzoate, poly(propylene glycol)-4-(dimethylamino) benzoate.

Among the examples described above, as the photosensitizer or co-initiator (E) to be added to the photosensitive resin composition of the present invention, at least one photosensitizer compound selected from benzophenone and derivatives thereof, thioxanthone and derivatives thereof, anthraquinone and derivatives thereof and coumarin derivatives is preferable.

Further, the content of the photosensitizer or co-initiator (E) in the photosensitive resin composition is preferably in a range of 0.5% to 15% by mass, more preferably in a range of 1% to 12% by mass, and particularly preferably in a range of 2% to 10% by mass with respect to the total solid content in the photosensitive resin composition from which solvents have been removed.

Further, the total amount of the photopolymerization initiator (A) and the photosensitizer or co-initiator (E) is preferably in a range of 0.1% to 15.0% by weight and more preferably in a range of 0.1% to 12.0% by weight with respect to the total solid content in the photosensitive resin composition.

(Other Components)

The photosensitive resin composition of the present invention may contain various additives such as a radical scavenger, a light stabilizer, a curing assistant, a thermal polymerization initiator, a surfactant, an adhesion assistant, a development accelerator, a thermal polymerization inhibitor, a dispersing agent, and other additives (a filler, an ultraviolet absorbing agent, and an aggregation inhibitor) as necessary.

(Light Stabilizer)

In the present invention, various light stabilizers may be added for improving light resistance. The kind of the light stabilizer is not particularly limited. Further, from the viewpoint of the general purpose, hindered amine-based light stabilizers such as bis(2,2,6,6-tetramethyl-4-piperidyl) adipate, bis(1,2,2,6,6-pentamethyl-4-piperidyl) adipate, bis(2,2,6,6-tetramethyl-4-piperidyl) sebacate, bis(1,2,2,6,6-pentamethyl-4-piperidyl) sebacate, tetrakis(2,2,6,6-tetramethyl-4-piperidyl)-1,2,3,4-tetraacrylate, and tetrakis (1,2,2,6,6-pentamethyl-4-piperidyl)-1,2,3,4-tetraacrylate; and hindered phenol-based light stabilizers such as pentaerythritol-tetrakis (3-(3′,5′-di-tert-butyl-4′-hydroxyphenyl) propionate are suitably used.

The content of the light stabilizer in the present invention is preferably in a range of 0.1% to 5.0% by mass, more preferably in a range of 0.2% to 4.0% by mass, and still more preferably in a range of 0.5% to 2.0% by mass with respect to the total solid content in the photosensitive resin composition. In a case where the content thereof is 0.1% by mass or less, desired light resistance cannot be obtained. Further, in a case where the content thereof is 5.0% by mass or greater, the sensitivity decreases, which is not preferable.

(Curing Assistant)

As the curing assistant, a compound having an epoxy ring may be used in order to increase the strength of the coated film which has been formed. It is preferable that the compound having an epoxy ring is used from the viewpoint that the thermal polymerization proceeds, the solvent resistance is improved, and the ITO sputtering suitability is improved.

The compound having an epoxy ring is a compound having two or more epoxy rings in a molecule, for example, a bisphenol A type compound, a cresol novolak type compound, a biphenyl type compound, or an alicyclic epoxy compound.

Examples of the bisphenol A type compound include EPOTOHTE YD-115, YD-118T, YD-127, YD-128, YD-134, YD-8125, YD-7011R, ZX-1059, YDF-8170, and YDF-170 (all trade names, manufactured by Tohto Chemical Industry Co., Ltd.); DENACOL EX-1101, EX-1102, and EX-1103 (all trade names, manufactured by Nagase Kasei Co., Ltd.); PLAXEL GL-61, GL-62, G101, and G102 (all trade names, manufactured by Daicel Corporation); and bisphenol F type compounds and bisphenol S type compounds which are similar to the above-described compounds. Further, epoxy acrylates such as Ebecryl 3700, 3701, and 600 (all trade names, manufactured by Daicel-UCB Co., Ltd.) can also be used.

Examples of the cresol novolak type compound include EPOTOHTE YDPN-638, YDPN-701, YDPN-702, YDPN-703, and YDPN-704 (all trade names, manufactured by Tohto Chemical Industry Co., Ltd.); DENACOL EM-125 (trade name, manufactured by Nagase Kasei Co., Ltd.); biphenyl type compounds such as 3,5,3′,5′-tetramethyl-4,4′-diglycidylbiphenyl; alicyclic epoxy compounds such as CELLOXIDE 2021, 2081, 2083, 2085, EPOLEAD GT-301, GT-302, GT-401, GT-403, and EHPE-3150 (all trade names, manufactured by Daicel Corporation); SANTOHTO ST-3000, ST-4000, ST-5080, and ST-5100 (all trade names, manufactured by Tohto Chemical Industry Co., Ltd.); and Epiclon 430, 673, 695, 850S, and 4032 (all made by DIC Corporation).

Further, other examples thereof include 1,1,2,2-tetrakis (p-glycidyloxyphenyl) ethane, tris(p-glycidyloxyphenyl) methane, triglycidyltris(hydroxyethyl) isocyanurate, o-phthalic acid diglycidyl ester, terephthalic acid diglycidyl ester, and amine type epoxy resins such as EPOTOHTE YH-434 and YH-434L (both trade names, manufactured by Nagase Kasei Co., Ltd.), and glycidyl ester in which a dimer acid is modified in a skeleton of a bisphenol A type epoxy resin.

Among these, the “molecular weight/number of epoxy rings” is preferably 100 or greater and more preferably in a range of 130 to 500. In a case where the “molecular weight/number of epoxy rings” is small, the curing properties are excellent, and shrinkage during curing is large. In a case where the “molecular weight/number of epoxy rings” is extremely large, the curing properties are insufficient, the reliability is not satisfactory, and the flatness deteriorates. Preferred examples of the compounds include EPOTOHTE YD-115, 118T, 127, YDF-170, YDPN-638, and YDPN-701 (all trade names, manufactured by Nagase Kasei Co., Ltd.), PLAXEL GL-61, GL-62, 3,5,3′, 5′-tetramethyl-4,4′ diglycidylbiphenyl, CELLOXIDE 2021, 2081, EPOLEAD GT-302, GT-403, and EHPE-3150 (all trade names, manufactured by Daicel Corporation).

The content of the curing assistant in the present invention is preferably in a range of 0.1% to 5.0% by mass, more preferably in a range of 0.2% to 4.0% by mass, and still more preferably in a range of 0.5% to 2.0% by mass with respect to the total solid content in the photosensitive resin composition. In a case where the content thereof is 0.1% by mass or less, the effect of accelerating curing cannot be obtained. Further, in a case where the content thereof is 5.0% by mass or greater, the light resistance deteriorates, which is a problem.

(Thermal Polymerization Initiator)

It is also effective that the photosensitive resin composition of the present invention contains a thermal polymerization initiator. Examples of the thermal polymerization initiator include various azo-based compounds and peroxide-based compounds. Examples of the azo-based compounds include azobis-based compounds. Further, examples of the peroxide-based compounds include ketone peroxide, peroxyketal, hydroperoxide, dialkyl peroxide, diacyl peroxide, peroxyester, and peroxydicarbonate.

(Surfactant)

From the viewpoint of improving the coating property, it is preferable that the photosensitive resin composition of the present invention is formed of various surfactants. The liquid properties (particularly, the fluidity) of the coating solution can be improved by the surfactants so that the uniformity of the coating thickness and the liquid saving property can be improved. That is, since the wettability to the substrate is improved by lowering the interfacial tension between the substrate and the coating solution and thus the coating property to the substrate is improved, it is also effective that a film having a uniform thickness with small thickness unevenness can be formed even in a case where a thin film having a several micrometers is formed with a small amount of liquid. Further, it is also effective in slit coating, which is likely to cause liquid exhaustion.

As the surfactants, various nonionic, cationic, and anionic surfactants can be used. Among these, a fluorine-based surfactant which is a nonionic surfactant and contains a perfluoroalkyl group is preferred.

The fluorine content of the fluorine-based surfactant is suitably in a range of 3% to 40% by mass, more preferably in a range of 5% to 30% by mass, and particularly preferably in a range of 7% to 25% by mass. In a case where the fluorine content is in the above-described range, it is effective in terms of the coating thickness uniformity and the liquid saving property, and the solubility in the composition is satisfactory.

Examples of the fluorine-based surfactant include MEGAFACE F171, MEGAFACE F172, MEGAFACE F173, MEGAFACE F177, MEGAFACE F141, MEGAFACE F142, MEGAFACE F143, MEGAFACE F144, MEGAFACE R30, and MEGAFACE F437 (all trade names, manufactured by DIC Corporation), FLUORAD FC430, FLUORAD FC431, and FLUORAD FC171 (all trade names, manufactured by Sumitomo 3M Ltd.), and SURFLON S-382, SURFLON SC-101, SURFLON SC-103, SURFLON SC-104, SURFLON SC-105, SURFLON SC1068, SURFLON SC-381, SURFLON SC-383, SURFLON S393, and SURFLON KH-40 (all trade names, manufactured by AGC, Inc.).

Examples of surfactants other than the fluorine-based surfactants include cationic surfactants such as a phthalocyanine derivative (commercially available product EFKA-745 (manufactured by Morishita & Co., Ltd.)), an organosiloxane polymer KP341 (manufactured by Shin-Etsu Chemical Co., Ltd.), (meth)acrylic acid-based (co)polymer Polyflow No. 75, No. 90, and No. 95 (manufactured by Kyoeisha Yushi Kagaku Kogyo Co., Ltd.), and W001 (manufactured by Yusho Co., Ltd.); nonionic surfactants such as polyoxyethylene lauryl ether, polyoxyethylene stearyl ether, polyoxyethylene oleyl ether, polyoxyethylene octyl phenyl ether, polyoxyethylene nonylphenyl ether, polyethylene glycol dilaurate, polyethylene glycol distearate, sorbitan fatty acid ester (PLURONIC L10, L31, L61, L62, 10R5, 17R2, 25R2, TETRONIC 304, 701, 704, 901, 904, and 150R1 (manufactured by BASF SE); and anionic surfactants such as W004, W005, and W017 (manufactured by Yusho Co., Ltd.).

The amount of the surfactant to be added is preferably in a range of 0.001% to 2.0% by mass and more preferably in a range of 0.005% to 1.0% by mass with respect to the total mass of the photosensitive resin composition.

Development Accelerator

Further, in a case where further improvement of the developability of the photosensitive resin composition is intended by promoting the alkali solubility of an uncured portion in the photosensitive resin composition layer, a development accelerator can be used for the photosensitive resin composition.

As such a development accelerator, an organic carboxylic acid is preferable, and a low-molecular-weight organic carboxylic acid having a molecular weight of 1000 or less is more preferable. Specific examples thereof include an aliphatic monocarboxylic acid such as formic acid, acetic acid, propionic acid, butyric acid, valeric acid, pivalic acid, caproic acid, diethylacetic acid, enanthic acid, or caprylic acid; an aliphatic dicarboxylic acid such as oxalic acid, malonic acid, succinic acid, glutaric acid, adipic acid, pimelic acid, suberic acid, azelaic acid, sebacic acid, brassic acid, methylmalonic acid, ethylmalonic acid, dimethylmalonic acid, methylsuccinic acid, tetramethylsuccinic acid, or citraconic acid; an aliphatic tricarboxylic acid such as tricarballylic acid, aconitic acid, or camphoronic acid; an aromatic monocarboxylic acid such as benzoic acid, toluic acid, cumic acid, hemelitic acid, or mesitylene acid; an aromatic polycarboxylic acid such as phthalic acid, isophthalic acid, terephthalic acid, trimellitic acid, trimesic acid, melophanic acid, or pyromellitic acid; and other carboxylic acids such as phenylacetic acid, hydroatropic acid, hydrocinnamic acid, mandelic acid, phenylsuccinic acid, atropic acid, cinnamic acid, methyl cinnamate, benzyl cinnamate, cinnamylidene acetic acid, coumaric acid, and umbellic acid.

(Thermal Polymerization Inhibitor)

It is preferable that a thermal polymerization inhibitor is added to the photosensitive resin composition of the present invention, and useful examples thereof include hydroquinone, p-methoxyphenol, di-tert-butyl-p-cresol, pyrogallol, tert-butylcatechol, benzoquinone, 4,4′-thiobis(3-methyl-6-tert-butylphenol), 2,2′-methylenebis(4-methyl-6-tert-butylphenol), and 2-mercaptobenzimidazole.

(Other Additives)

In addition to the additives described above, other examples thereof include a filler such as glass or alumina; an ultraviolet absorbing agent such as 2-(3-tert-butyl-5-methyl-2-hydroxyphenyl)-5-chlorobenzotriazole or alkoxybenzophenone; and an aggregation inhibitor such as sodium polyacrylate.

The photosensitive resin composition of the present invention can be prepared by adding each of the above-described components, that is, the photopolymerization initiator (A), the solvent (B), the polymerizable monomer (C), the alkali-soluble resin (D), and other additives such as the photosensitizer or co-initiator (E) as necessary and mixing the mixture.

(Light Absorbing Layer)

The light absorbing layer absorbs light reflected by the lens or the light reflecting layer 13 or light that is incident from the outside and repeats reflection in the first support 12 and suppresses stray light. In this manner, generation of sidebands can be suppressed, and the light use efficiency can be further improved.

The light absorbing layer has a first opening for each lens and has a first opening, for example, on the optical axis of each of the plurality of lenses. The light absorbing layer and the light reflecting layer have the same opening pattern. As the aligning of the openings described above, the light reflecting layer and the light absorbing layer are disposed in a state where the first opening of the light absorbing layer and the second opening of the light reflecting layer are aligned.

In a case where the opening ratio of the first opening is extremely small, the light use efficiency decreases. Meanwhile, in a case where the opening ratio thereof is extremely large, the directivity deteriorates.

In the first aspect, from this viewpoint, the opening ratio of the first opening of the light absorbing layer is preferably in a range of 30% to 70%. The opening ratio thereof is more preferably in a range of 30% to 60% and still more preferably in a range of 35% to 55%.

Further, in the second aspect, the opening ratio of the first opening of the light absorbing layer is preferably in a range of 100/o to 75%. The opening ratio thereof is more preferably in a range of 10% to 70% and still more preferably in a range of 15% to 65%.

In the configuration having both the light absorbing layer and the light reflecting layer, the opening ratio of the openings provided in the light absorbing layer and the light reflecting layer is an optimum point of 25% in order to improve the light usage rate represented by T/T0. In a case where the opening ratio decreases, the effect of recycling light using the light reflecting layer increases, and the front brightness, that is, the maximum brightness value is improved. In a case where the opening ratio is excessively reduced, for example, 100% or less, the effect of light loss during light recycling increases, and the front brightness rather decreases.

The opening ratio of the first openings 18b of the light absorbing layer 18 is defined by the opening width of the first openings 18b with respect to the pitch at which the first openings 18b are arranged. In a case where the pitch is 100 μm and the opening width is 25 μm, the opening ratio becomes 25% in 25/100.

In the light reflecting layer 13, as in the case of the light absorbing layer 18, the opening ratio of the second opening 13b of the light reflecting layer 13 is defined by the opening width of the second opening 13b with respect to the pitch at which the second openings 13b are arranged. In a case where the pitch is 100 μm and the opening width is 25 pan, the opening ratio becomes 25% in 25/100.

The opening width is obtained by obtaining an image including the light absorbing layer 18 having the first opening 18b and an image including the light reflecting layer 13 having the second opening 13b and acquiring the lengths of the positions corresponding to the opening widths of the first opening 18b and the second opening 13b using each image.

The light absorbing layer is not particularly limited. For example, carbon black, titanium nitride, and silver ink can be used, and those used for a black matrix such as a LCD or organic electro luminescence (EL) can be appropriately used.

Since the silver ink becomes a black absorber and becomes a silver mirror in the heating process after ink application, in a case where a film is coated with the silver ink, the front surface of the ink is heated at a high temperature, and the rear surface thereof is heated at a lower temperature, the front surface becomes a mirror surface mirror that plays a role of a reflecting layer and the rear surface becomes a black absorber, thereby simply preparing the reflecting layer and the black absorbing layer in the process

The reflectivity of the light absorbing layer is preferably 20% or less, and more preferably 10% or less and most preferably 7% or less in order to increase the light shielding property in the oblique direction, that is, to reduce the visibility in the oblique direction. The reflectivity of the light absorbing layer is obtained as follows. Using a spectrophotometer (V-550, manufactured by JASCO Corporation), a material used for the light absorbing layer is formed on a polyethylene terephthalate (PET) base material, light is incident from the formed surface, and the reflectivity at a wavelength of 380 nm to 780 nm is measured, and the average value thereof is acquired. This average value is the reflectivity of the light absorbing layer.

In addition, the light absorbing layer 18 and the light reflecting layer 13 may be formed integrally or separately. In a case of the integrated configuration, the surface 13a of the light reflecting layer 13 functions as the light absorbing layer 18, the reflectivity is less than 90% which is different from the reflectivity of the surface 13a, and the layer absorbs light. Even in this case, the reflectivity is preferably 20% or less, more preferably 10% or less, and most preferably 7% or less as described above.

The number of components can be further reduced in the case of the integrated configuration of the light absorbing layer 18 and the light reflecting layer 13 as compared to the separate configuration, and thus the configuration can be simplified. In a case of the separate configuration, it is necessary to align the first opening 18b of the light absorbing layer 18 and the second opening 13b of the light reflecting layer 13. However, in the case of the integrated configuration, since the above-described aligning is unnecessary, the production step can be simplified.

The method of producing the light absorbing layer is not particularly limited. For example, a plate-like member serving as the light absorbing layer can be formed by etching processing or laser processing. Alternatively, a light absorbing layer can be formed by forming a film which becomes a light absorbing layer on a base material according to a gas phase method such as vapor deposition or a liquid phase method such as coating.

(Second Support)

In a case where a high-refractive index material is used as the second support, the thickness is preferably 30 μm or less from the viewpoint that the brittleness does not deteriorate. The thickness thereof is more preferably 10 μm or less and more preferably approximately 1 μm.

From the viewpoint that sidebands are not generated, the refractive index of the second support is preferably 1.30 or greater, more preferably 1.4 or greater, and still more preferably 1.6 or greater, particularly preferably 1.80 or greater, and most preferably 1.9 or greater. In addition, from the viewpoint that the brittleness of the second support does not deteriorate, the refractive index thereof is preferably 2.50 or less, more preferably 2.20 or less, still more preferably less than 2.10, and even still more preferably 2.05 or less.

The refractive index of the second support can be adjusted according to the kind of the component used for forming a layer, similarly to the first support. As the component used for forming a layer, a polymerizable composition containing a polymerizable compound and a polymerization initiator can be used for formation, similar to the first support. Alternatively, a resin layer containing a resin as a main component may be used similarly to the first support.

The layer may contain particles in order to adjust the refractive index of the second support, similar to the first support. The particles are not particularly limited and may be inorganic particles or organic particles.

The layer may contain one kind of particles or a mixture of two or more kinds of particles. From the viewpoint of suppressing the scattering property, it is preferable that the size of the particles decreases. Therefore, the particle size as the primary particle diameter is preferably 100 nm or less, more preferably 30 nm or less, and still more preferably 25 nm or less. Further, the particle size as the primary particle diameter is preferably 1 nm or greater. The primary particle diameter of the above-described particles is a value calculated as a number average value obtained by measuring the particle diameters of 50 particles using a scanning electron microscope (SEM). The content of the particles in the layer containing the above-described particles may be appropriately set so as to obtain an average refractive index preferably in the above-described range.

From the viewpoint of adjusting the refractive index, the refractive index (the refractive index with respect to light having a wavelength of 550 nm) of the above-described particles is preferably in a range of 2.00 to 3.00 and more preferably in a range of 2.05 to 2.50. Here, the refractive index of the particles is a value measured according to the following method. A resin material having a known refractive index is doped with the particles to prepare a resin material in which the particles have been dispersed. A silicon substrate or a quartz substrate is coated with the prepared resin material to form a resin film. The refractive index of the formed resin film is measured using an ellipsometer, and the refractive index of the particles is acquired from the resin material constituting the resin film and the volume fraction of the particles. The refractive index of the titanium oxide particles used in the examples described later is a value acquired according to the above-described method.

[Planar Light Source Device]

A planar light source device according to one embodiment of the present invention includes at least the above-described louver film and a light source.

<Configuration of Planar Light Source Device>

Examples of the configuration of the planar light source device includes a device in an edge light mode which includes at least a light source and a light guide plate and optionally includes a reflection plate and a diffusion plate; and a direct type device which includes at least a reflection plate, a plurality of light sources arranged on the reflection plate, and a diffusion plate. The above-described planar light source device may have any configuration. The details are described in JP3416302B, JP3363565B, JP4091978B, and JP3448626B, and the contents of these publications are incorporated in the present invention. Further, the light source may be a white light source or a monochromatic light source using a blue LED or an ultraviolet LED. A white light source is preferable from the viewpoint that color conversion is not required and the configuration can be made simple. A monochromatic light source is preferable from the viewpoint that the directivity of light can be controlled without chromatic aberration. In a case of a blue or ultraviolet light source, a wavelength conversion film obtained by using quantum dot particles or a phosphor may be provided between the louver film and the light source. In place of the wavelength conversion film, a liquid crystal panel may be provided with a color filter containing quantum dot particles or a phosphor. Since light that has passed through the liquid crystal layer of the liquid crystal panel with high directivity is color-converted into quantum dot particles and the converted light is diffused, the viewing angle can be widened.

Further, the planar light source device may include an optical film such as a reflective type polarizer, a prism sheet, a diffusion sheet, and a wavelength conversion film.

For example, in the example illustrated in FIG. 8, the planar light source device includes a reflective type polarizer 20 between the louver film 2 and the diffusion plate 14, that is, between the louver film 2 and the light source 16.

With the configuration including the reflective type polarizer 20, light use efficiency can be improved by recycling light. In the example illustrated in FIG. 8, the various louver films 2 illustrated in FIGS. 5 to 7 can be used.

As the reflective type polarizer 20, a general reflective type polarizer can be used. For example, DBEF (product name, manufactured by 3M Company) or the like can be used.

[Liquid Crystal Display]

A liquid crystal display device according to one embodiment of the present invention includes at least the above-described planar light source device and a liquid crystal panel.

<Configuration of Liquid Crystal Display Device>

The liquid crystal panel typically includes at least a viewing-side polarizer, a liquid crystal cell, and a backlight-side polarizer.

In one embodiment of the liquid crystal display device, the liquid crystal display device has a liquid crystal cell in which a liquid crystal layer is interposed between substrates which oppose each other and at least one of which is provided with an electrode, and the liquid crystal cell is disposed between two polarizers. The liquid crystal display device comprises a liquid crystal cell in which liquid crystals are sealed between upper and lower substrates, and displays an image by applying a voltage so that the alignment state of the liquid crystals is changed. Further, the liquid crystal display device includes a polarizing plate protective film, an optical compensation member for performing optical compensation, and an accompanying functional layer such as an adhesive layer, as necessary. In addition to (or in place of) a color filter substrate, a thin-layer transistor substrate, a lens film, a diffusion sheet, a hard coat layer, an antireflection layer, a low-reflection layer, and an anti-glare layer, a surface layer such as a forward scattering layer, a primer layer, an antistatic layer, or an undercoat layer may be disposed.

In order to widen the viewing angle of light after passing through the liquid crystal layer of the liquid crystal panel with high directivity, a color filter containing the quantum dot particles or the phosphor described above or a functional layer that alleviates the directivity of light such as a lens film, an optical diffusion sheet, or a diffraction film may be provided on the viewing side of the viewing-side polarizer.

The planar light source device included in the liquid crystal display device is configured as described above.

The liquid crystal cell, the polarizing plate, the polarizing plate protective film, and the like constituting the liquid crystal display device according to one embodiment of the present invention are not particularly limited, and those prepared by a known method and commercially available products can be used without any limitation. In addition, a known intermediate layer such as an adhesive layer can also be provided between respective layers.

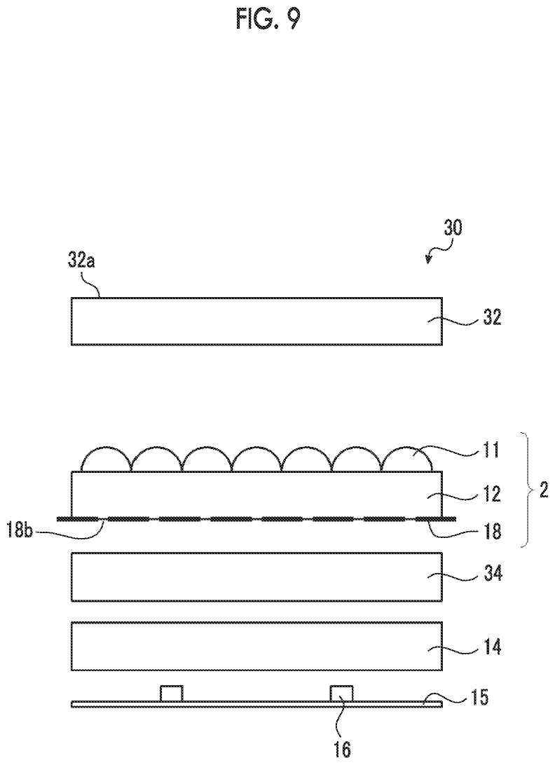

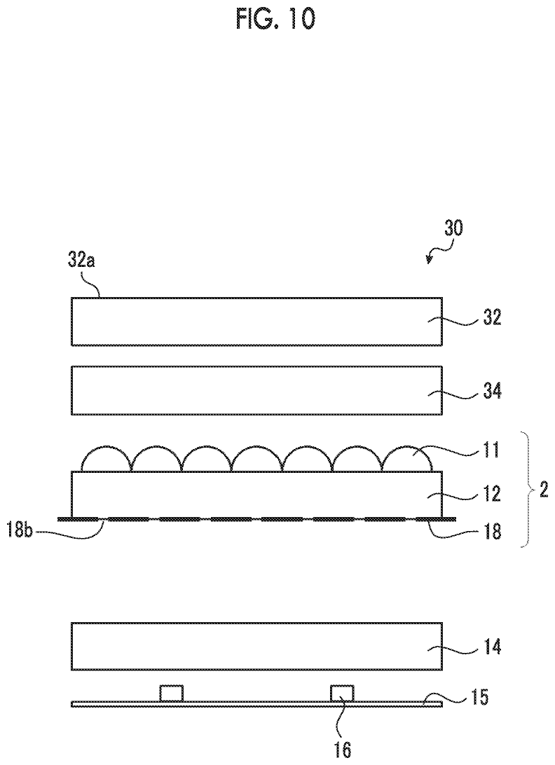

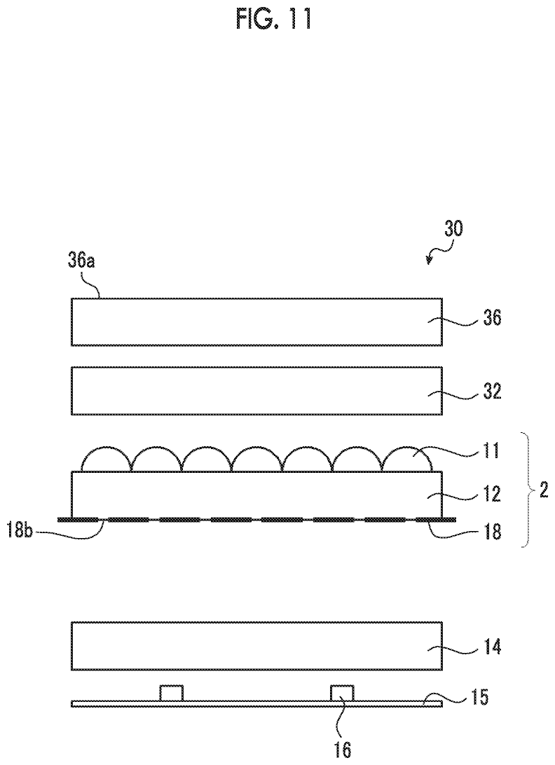

The liquid crystal display device may have a configuration in which the louver film 2 is disposed between the liquid crystal cell 32 and the backlight-side polarizer 34 as in a liquid crystal display device 30 illustrated in FIG. 9. Alternatively, the liquid crystal display device may have a configuration in which the louver film 2 is disposed between the backlight-side polarizer 34 and the diffusion plate 14 as illustrated in FIG. 10. Alternatively, the liquid crystal display device may have a configuration in which the viewing-side polarizer 36 is provided on a side opposite to the light source 16 of the liquid crystal cell 32 without providing the backlight-side polarizer as illustrated in FIG. 11. Further, various louver films 2 illustrated in FIGS. 5 to 7 can also be used even in the liquid crystal display device illustrated in FIGS. 9 to 11.

Further, the position where the louver film 2 disposed is not limited to the light source side with respect to the liquid crystal cell 32. For example, in the liquid crystal display device 30 illustrated in FIG. 9, the louver film 2 is disposed between the liquid crystal cell 32 and the backlight-side polarizer 34, but the louver film 2 may be disposed on the surface 32a of the liquid crystal cell 32, that is, on the display surface.

In the liquid crystal display device 30 illustrated in FIG. 10, the louver film 2 is disposed between the backlight-side polarizer 34 and the diffusion plate 14, but the louver film 2 may be disposed on the surface 32a of the liquid crystal cell 32, that is, on the display surface.

Even in the liquid crystal display device 30 illustrated in FIG. 11, the louver film 2 is disposed between the liquid crystal cell 32 and the diffusion plate 14, but the louver film 2 may be disposed on the surface 36a of the viewing-side polarizer 36 provided on the liquid crystal cell 32. In this manner, the louver film 2 can be disposed on the outermost surface side of the liquid crystal display device 30. Even at such a position where the louver film 2 is disposed, the directivity for the visibility can be improved while the light use efficiency is maintained, and projection of an image in a region where display is not desired can be suppressed.

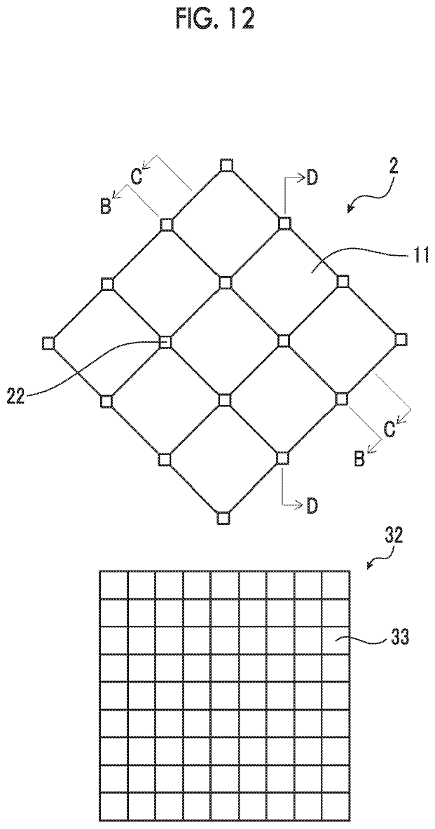

In a case where the lenses of the louver film are formed as a two-dimensional lens array, it is preferable that the shape as viewed in the optical axis direction is a square shape, the plurality of lenses are arranged in a square lattice form, moire prevention points are formed at the intersections of the arranged lenses, and the lens arrangement direction is inclined at 25° to 65° with respect to the pixel arrangement direction of the liquid crystal panel. These points will be described with reference to FIGS. 12 to 15.

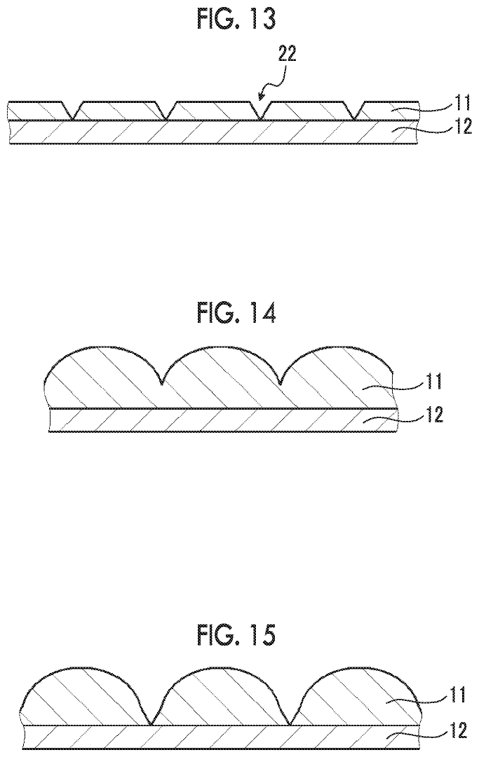

FIG. 12 is a schematic view illustrating a part of the louver film 2 and a part of the liquid crystal cell 32 as viewed in the optical axis direction of the lens, with these relative positions being shifted in the plane direction. FIG. 13 is a cross-sectional view taken along line B-B of FIG. 12. FIG. 14 is a cross-sectional view taken along line C-C of FIG. 12. FIG. 15 is a cross-sectional view taken along line D-D of FIG. 12.

As illustrated in FIG. 12, the lenses 11 is a two-dimensional lens array having a square shape as viewed in the optical axis direction of the lenses 11. The plurality of lenses 11 are arranged in a square lattice. Further, as illustrated in FIG. 12, the arrangement direction of the lenses 11 is inclined by approximately 450 with respect to the arrangement direction of the pixels 33 of the liquid crystal cell 32.

Here, as illustrated in FIGS. 12 and 13, concave portions are formed as moire prevention points 22 at the vertexes (four corners in the plane direction) of the plurality of lenses 11 arranged in a square lattice form.

In addition, the arrangement of the lenses 11 may be two-dimensionally arranged. Further, the two-dimensional arrangement is not particularly limited and may be an arrangement in a hexagonal shape other than the arrangement in a square shape. By arranging the lenses 11 in a hexagonal shape, the light use efficiency is improved and the brightness is improved.

In a case where a plurality of lenses of the louver film are regularly arranged, there is a concern that moire occurs due to the relationship with other members having a regular arrangement.

For example, in a case where a liquid crystal cell having a plurality of pixels arranged regularly and a louver film are disposed so as to overlap with each other, the moire may occur.

Meanwhile, it was found that the moire can be reduced by inclining the arrangement direction of the lenses 11 by 25° to 65° with respect to the arrangement direction of the pixels of the liquid crystal panel and forming the moire prevention points 22 at the vertexes of the lenses 11. Typically, the moire occurs due to a difference frequency between a plurality of pixel patterns regularly arranged in the liquid crystal cell and shadow (boundary line) patterns among the plurality of lenses 11. In addition, in a case where the arrangement direction of the lenses 11 is inclined by approximately 450 with respect to the arrangement direction of the pixels 33 of the liquid crystal cell 32, the moire occurs due to the difference frequency between patterns that appear at the time of integration of the shadow (boundary line) patterns among the plurality of lenses 11 in the arrangement direction of the pixels 33 of the liquid crystal cell 32. The patterns that appear at the time of integration of the shadow (boundary line) patterns among the plurality of lenses 11 in the arrangement direction of the pixels 33 of the liquid crystal cell 32 appear because the patterns are weak on the lattice points of the plurality of lenses 11 arranged in a square lattice form and the pattern intensity is high except on the lattice points. By making the shadows on the lattice points of the plurality of lenses 11 arranged in a square lattice pattern darker or thicker, the pattern intensities of the portions on the lattice points and the portions other than the lattice points can be made equal, and the patterns on the side of the louver film can be eliminated. Therefore, it is considered that the plurality of pixel patterns regularly arranged in the liquid crystal cell and the patterns that can take a difference frequency are eliminated, and thus the moire is unlikely to occur.

The size (area) of the moire prevention point 22 is preferably in a range of 0.01% to 10% with respect to the size (area) of one two-dimensionally disposed lens 11.

Further, the depth of the moire prevention point 22 is preferably in a range of 0.1% to 40% with respect to the pitch of the lenses.

In the example illustrated in FIG. 12, the planar shape of the moire prevention point 22 is a square, but the present invention is not limited thereto. In addition, various shapes such as a rectangular shape, a triangular shape, a polygonal shape, a circular shape, and an irregular shape can be employed.

Further, the planar shape of the moire prevention point 22 may be symmetric or asymmetric.

Further, in the example illustrated in FIG. 13, the moire prevention points 22 are set as concave portions, but the present invention is not limited thereto as long as the amount of transmitted light can be changed. For example, the moire prevention points 22 may be convex portions. Alternatively, dots printed with ink may be used.

The method of forming the moire prevention points 22 formed by the concave portions is not particularly limited. For example, in a case where the lens 11 is formed by embossing, a mold that forms the moire prevention points 22 simultaneously with the formation of the lenses 11 may be used.

Further, in a case where the lenses of the louver film lens are formed as lenticular lenses (one-dimensional array lens), the pitch of the lenses is preferably in a range of 50 μm to 300 μm from the viewpoint of the moire. The pitch thereof is more preferably in a range of 50 μm to 200 μm. The pitch thereof is still more preferably in a range of 50 nm to 150 μm. It is preferable that the lens arrangement direction is inclined by 0.1° to 20° with respect to the pixel arrangement direction of the liquid crystal panel. In this manner, interference between the pitch of the pixels of the panel and the pitch of the lenses is suppressed, and thus the moire is unlikely to be seen.

### EXAMPLES

Hereinafter, the present invention will be described in more detail based on examples.

### Example 1

In Example 1, a polyethylene terephthalate film (trade name: COSMOSHINE (registered trademark) A4300, manufactured by Toyobo Co., Ltd., thickness of 125 μm, refractive index of 1.57) was prepared as a first support. The surface of the first support was coated, using a bar coater, with a titanium oxide particle-containing polymerizable composition (composition type 2) prepared to have a refractive index of 1.55 according to the following item 1, the support was exposed at 5 J/cm² so that the composition was cured in a nitrogen atmosphere using a UV exposure machine (EXECURE 3000W, manufactured by HOYA CANDEO OPTRONICS Corp.) while an uneven roller having a surface shape inverted from the shape to be formed was pressed so that each convex arc (lens) whose cross section had a curvature radius of 57 μm was formed on the surface at a pitch of 100 μm, and the support was peeled off from the uneven roller to prepare an uneven shape on the surface.

Thereafter, the surface of the first support opposite to the surface on which the uneven shape was formed was coated with the following K pigment dispersion 1 through a stripe-like mask having a pitch of 100 μm and a width of 50 μm and dried, and a light absorbing layer having a pitch of 100 μm, an opening width of 50 μm, an opening ratio of 50%, and a film thickness of 2 μm was formed such that the center thereof in the opening width direction was positioned to match the position of the vertex of the lens convex portion, thereby preparing a louver film A. The light absorbing layer contains carbon black, and “CB” in the columns of the material of the light absorbing layer in Table 1 indicates carbon black.

K Pigment Dispersion 1

Carbon black, a dispersing agent, a polymer, and a solvent were mixed so that the K pigment dispersion 1 had the following composition, thereby obtaining a K pigment dispersion 1.

(K Pigment Dispersion 1)
Resin-coated carbon black prepared according to the description in paragraph [0036] to [0042] of JP5320652B: 3.4% by mass
Dispersing agent 1 [the following structure]: 0.13% by mass
Polymer: 16.47% by mass

(Benzyl methacrylate/methacrylic acid=random copolymer with molar ratio of 72/28, weight-average molecular weight of 37000)
Propylene glycol monomethyl ether acetate: 80.0% by mass

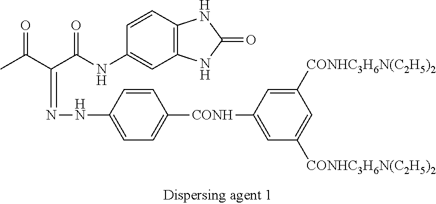

1. Preparation of Titanium Oxide Particle-Containing Polymerizable Composition (Composition Type 1)

18.2 parts by mass of trimethylolpropane triacrylate, 80.8 parts by mass of lauryl methacrylate, and 1 part by mass of a photopolymerization initiator (Irgacure (registered trademark) 819, manufactured by BASF SE) were mixed.

The above-described mixture (hereinafter, also referred to as a binder) was doped with a slurry (solvent:methyl ethyl ketone, titanium oxide particle concentration of 30% by mass) in which titanium oxide (TiO₂) particles (primary particle diameter of 100 nm or less) were dispersed, and then sufficiently mixed to prepare a titanium oxide particle-containing polymerizable composition. The above-described titanium oxide particles are titanium oxide particles that have been subjected to a surface treatment with aluminum oxide to suppress the photoactivity of titanium oxide, and the refractive index thereof is 2.40. In order to adjust the average refractive index of each layer described below, the amount of the titanium oxide particle slurry added to the binder was set within a range where the ratio of the binder to the titanium oxide particle slurry was in a range of 7:3 to 6:4 on a mass basis.

### Example 2

In Example 2, a polyethylene terephthalate film (trade name: COSMOSHINE (registered trademark) A4300, manufactured by Toyobo Co., Ltd., thickness of 125 Gm, refractive index of 1.57) was prepared as a first support. The surface of the first support was coated, using a bar coater, with a titanium oxide particle-containing polymerizable composition (composition type 2) prepared to have a refractive index of 1.55 according to the above-described item 1, the support was exposed at an irradiation dose of 5 J/cm² so that the composition was cured in a nitrogen atmosphere using a UV exposure machine (EXECURE 3000W, manufactured by HOYA CANDEO OPTRONICS Corp.) while an uneven roller having a surface shape inverted from the shape to be formed was pressed so that each convex arc (lens) whose cross section had a curvature radius of 57 μm was formed on the surface at a pitch of 100 μm, and the support was peeled off from the uneven roller to prepare an uneven shape on the surface.

Thereafter, the surface of the first support opposite to the surface on which the uneven shape was formed was coated with the above-described K pigment dispersion 1 through a stripe-like mask having a pitch of 100 μm and a width of 50 μm and dried, and a light absorbing layer having a pitch of 100 μm, an opening width of 50 μm, an opening ratio of 50%, and a film thickness of 2 μm was formed such that the center thereof in the opening width direction was positioned to match the position of the vertex of the lens convex portion. Thereafter, Ag was vapor-deposited on the light absorbing layer through a mask having the same pattern as the pattern of the light absorbing layer, and a light reflecting layer having a pitch of 100 μm, an opening width of 50 μm, and an opening ratio of 50% was formed such that the center thereof in the opening width direction was positioned to match the position of the vertex of the lens convex portion, thereby preparing a louver film B.

### Example 3

In Example 3, a polyethylene terephthalate film (trade name: COSMOSHINE (registered trademark) A4300, manufactured by Toyobo Co., Ltd., thickness of 75 μm, refractive index of 1.57) was prepared as a first support. The surface of the first support was coated, using a bar coater, with a titanium oxide particle-containing polymerizable composition (composition type 2) prepared to have a refractive index of 1.69 according to the above-described item 1, the support was exposed at an irradiation does of 5 J/cm² so that the composition was cured in a nitrogen atmosphere using a UV exposure machine (EXECURE 3000W, manufactured by HOYA CANDEO OPTRONICS Corp.) while an uneven roller having a surface shape inverted from the shape to be formed was pressed so that each convex arc (lens) whose cross section had a curvature radius of 50 μm was formed on the surface at a pitch of 100 μm, and the support was peeled off from the uneven roller to prepare an uneven shape on the surface.

Thereafter, the surface of the first support opposite to the surface on which the uneven shape was formed was coated with the above-described K pigment dispersion 1 through a stripe-like mask having a pitch of 100 μm and a width of 35 μm and dried, and a light absorbing layer having a pitch of 100 μm, an opening width of 35 μm, an opening ratio of 35%, and a film thickness of 2 μm was formed such that the center thereof in the opening width direction was positioned to match the position of the vertex of the lens convex portion, thereby preparing a louver film C.

### Example 4

In Example 4, a polyethylene terephthalate film (trade name: COSMOSHINE (registered trademark) A4300, manufactured by Toyobo Co., Ltd., thickness of 75 μm, refractive index of 1.57) was prepared as a first support. The surface of the first support was coated, using a bar coater, with a titanium oxide particle-containing polymerizable composition (composition type 2) prepared to have a refractive index of 1.69 according to the above-described item 1, the support was exposed at an irradiation does of 5 J/cm² so that the composition was cured in a nitrogen atmosphere using a UV exposure machine (EXECURE 3000W, manufactured by HOYA CANDEO OPTRONICS Corp.) while an uneven roller having a surface shape inverted from the shape to be formed was pressed so that each convex arc (lens) whose cross section had a curvature radius of 50 μm was formed on the surface at a pitch of 100 μm, and the support was peeled off from the uneven roller to prepare an uneven shape on the surface.

Thereafter, the surface of the first support opposite to the surface on which the uneven shape was formed was coated with the above-described K pigment dispersion 1 through a stripe-like mask having a pitch of 100 μm and a width of 35 μm and dried, and a light absorbing layer having a pitch of 100 μm, an opening width of 35 μm, an opening ratio of 35%, and a film thickness of 2 μm was formed such that the center thereof in the opening width direction was positioned to match the position of the vertex of the lens convex portion. Thereafter, Ag was vapor-deposited on the light absorbing layer through a mask having the same pattern as the pattern of the light absorbing layer, and a light reflecting layer having a pitch of 100 μm, an opening width of 35 μm, and an opening ratio of 35% was formed such that the center thereof in the opening width direction was positioned to match the position of the vertex of the lens convex portion, thereby preparing a louver film D.

### Example 5

In Example 5, a polyethylene terephthalate film (trade name: COSMOSHINE (registered trademark) A4300, manufactured by Toyobo Co., Ltd., thickness of 75 μm, refractive index of 1.57) was prepared as a second support. One surface of the second support and the surface of the first support of Example 3 on which the light absorbing layer had been formed were bonded to each other to prepare a louver film E.

### Example 6

In Example 6, a polyethylene terephthalate film (trade name: COSMOSHINE (registered trademark) A4300, manufactured by Toyobo Co., Ltd., thickness of 75 μm, refractive index of 1.57) was prepared as a second support. One surface of the second support and the surface of the first support of Example 4 on which the light absorbing layer and the light reflecting layer had been formed were bonded to each other to prepare a louver film F.

### Example 7

In Example 7, a louver film G was prepared in the same manner as in Example 5 except that a glass substrate was coated, using a bar coater, with a titanium oxide particle-containing polymerizable composition (composition type 2) prepared to have a refractive index of 1.90 according to the above-described item 1, and the substrate was exposed to ultraviolet rays at an irradiation dose of 5 J/cm² so that the composition was cured in a nitrogen atmosphere using a UV exposure machine (EXECURE 3000W, manufactured by HOYA CANDEO OPTRONICS Corp.) to form a second support having a thickness of 25 μm.

### Example 8

In Example 8, a louver film H was prepared in the same manner as in Example 6 except that a glass substrate was coated, using a bar coater, with a titanium oxide particle-containing polymerizable composition (composition type 2) prepared to have a refractive index of 1.90 according to the above-described item 1, and the substrate was exposed to ultraviolet rays at an irradiation dose of 5 J/cm² so that the composition was cured in a nitrogen atmosphere using a UV exposure machine (EXECURE 3000W, manufactured by HOYA CANDEO OPTRONICS Corp.) to form a second support having a thickness of 25 μm.

### Example 9

In Example 9, a louver film 1 was prepared in the same manner as in Example 4 except that the method of forming the light reflecting layer formed on the light absorbing layer formed on the first support was changed as follows.

The following coating solution was prepared as a composition for forming a cholesteric liquid crystal layer.

Composition for Forming Cholesteric Liquid Crystal Layer

| | | |
|---|---|---|
| Liquid crystal compound (LC1) shown below | 100 | parts by mass |
| Chiral agent (C1) shown below | 2.5 | parts by mass |
| Photopolymerization initiator (Irgacure 819, manufactured by BASE SE) | 0.75 | parts by mass |
| Surfactant (W1) shown below | 0.05 | parts by mass |
| Surfactant (W2) shown below | 0.01 | parts by mass |
| Methyl ethyl ketone | 250 | parts by mass |
| Cyclohexanone | 50 | parts by mass |

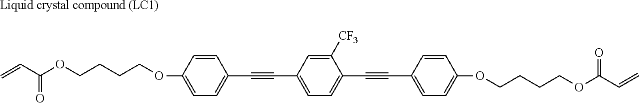 [SMILES: "Liquid crystal compound (LC1)" ; C=CC(=O)OCCCCOc1ccc(C#Cc2ccc(C#Cc3ccc(OCCCCOC(=O)C=C)cc3)c(C(F)(F)F)c2)cc1]

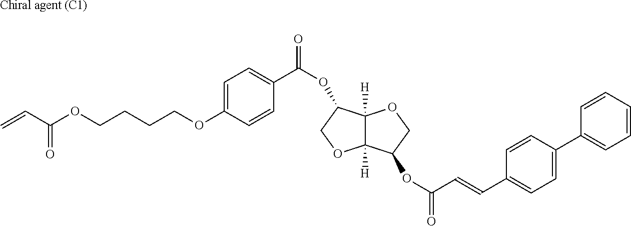 [SMILES: "Chiral agent (C1)" ; C=CC(=O)OCCCCOc1ccc(C(=O)O[C@H]2CO[C@H]3[C@@H]2OC[C@H]3OC(=O)/C=C/c2ccc(-c3ccccc3)cc2)cc1]

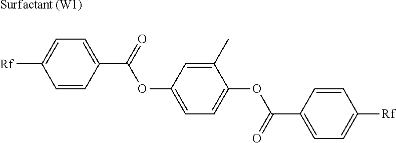

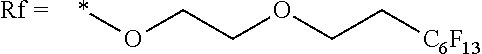

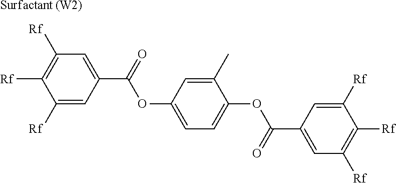

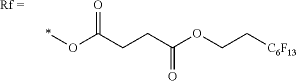

A rubbing treatment was performed on the surface of the first support opposite to the surface on which the uneven shape was formed using a rubbing device. At this time, the longitudinal direction of the long film was parallel to the transport direction, and the rotation axis of the rubbing roller was set to be in a direction of 45° clockwise with respect to the longitudinal direction of the film.

The surface which had been subjected to the rubbing treatment was coated with the above-described composition for forming a coating solution cholesteric liquid crystal layer such that the film thickness thereof was set to 3 μm using a wire bar to form a film formed of a polymerizable liquid crystal composition. Next, this film was heated at 70° C. for 1 minute to perform a cholesteric alignment treatment.

Thereafter, the coated film which had been cooled to 25° C. was irradiated with ultraviolet rays at an irradiation dose of 10 mW/cm² for 10 seconds in an air atmosphere using an ultraviolet irradiation device EXECURE 3000-W (manufactured by HOYA CANDEO OPTRONICS Corp.) provided with a high-pressure mercury lamp from the coating surface side using an OHP sheet on which black ink had been printed in a predetermined pattern to perform primary curing. Further, the above-described illuminance is the illuminance measured in a range of 300 nm to 390 nm using UVR-T1 (UD-T36; manufactured by TOPCON Corporation). Further, the film was irradiated with ultraviolet rays at an irradiation dose of 50 mW/cm² for 30 seconds from the coating surface side through a mask to perform secondary curing.

Thereafter, the mask was removed, the film which had been coated with the coating solution for a cholesteric liquid crystal was irradiated with ultraviolet rays at an irradiation dose of 50 mW/cm² for 40 seconds in a nitrogen atmosphere using an ultraviolet irradiation device from the coating surface side while being heated at 130° C., thereby obtaining a louver film 1 which had a cholesteric liquid crystal layer having an isotropic phase portion and a cholesteric liquid crystalline phase portion in one layer, as a light reflecting layer. In Table 1, the cholesteric liquid crystal is noted as “CLC”.

### Example 10

In Example 10, a louver film K was prepared in the same manner as in Example 4 except that the opening ratios of the light reflecting layer and the light absorbing layer were changed to 25%.

### Example 11

In Example 11, a louver film L was prepared in the same manner as in Example 10 except for a change to a polyethylene terephthalate film (trade name: COSMOSHINE (registered trademark) A4300, manufactured by Toyobo Co., Ltd., thickness of 50 μm, refractive index of 1.57) as a first support.

### Example 12

In Example 12, a polyethylene trephthalate film (trade name: COSMOSHINE (registered trademark) A4300, manufactured by Toyobo Co., Ltd., thickness of 75 μm, refractive index of 1.57) was prepared as a second support. One surface of the second support and the surface of the first support of Example 11 on which the light absorbing layer and the light reflecting layer had been formed were bonded to each other to prepare a louver film M.

### Example 13

In Example 13, a louver film N was prepared in the same manner as in Example 11 except that the opening ratios of the light reflecting layer and the light absorbing layer were changed to 16%.

### Example 14

In Example 14, a louver film O was prepared in the same manner as in Example 11 except for a change to an uneven roller having a surface shape inverted from the shape to be formed so that a shape in which hemispherical arcs (lenses) with a curvature radius of 50 μm were arranged in a square shape at a pitch of 100 μm was formed on the surface.

### Example 15

In Example 15, a louver film P was prepared in the same manner as in Example 13 except for a change to an uneven roller having a surface shape inverted from the shape to be formed so that a shape in which hemispherical arcs (lenses) with a curvature radius of 50 μm were arranged in a square shape at a pitch of 100 μm was formed on the surface.

### Example 16

In Example 16, a louver film Q was prepared in the same manner as in Example 14 except for a change to a polyethylene terephthalate film (trade name: COSMOSHINE (registered trademark) A4300, manufactured by Toyobo Co., Ltd., thickness of 38 μm, refractive index of 1.57) as a first support.

### Example 17

In Example 17, a louver film R was prepared in the same manner as in Example 11 except for a change to an uneven roller having a surface shape inverted from the shape to be formed so that a shape in which hemispherical arcs (lenses) with a curvature radius of 50 μm were arranged in a hexagonal shape at a pitch of 100 μm was formed on the surface.

### Comparative Example 1

A polyethylene terephthalate film (trade name: COSMOSHINE (registered trademark) A4300, manufactured by Toyobo Co., Ltd., thickness of 75 μm, refractive index of 1.57) was prepared as a second support, and Ag was vapor-deposited on one surface side through a stripe-like mask with a pitch of 333 μm and a width of 166.5 μm to form a light reflecting layer.

Next, an uneven roller having a surface shape inverted from the shape to be formed was prepared so that each convex arc (lens) whose cross section had a curvature radius of 167 μm was formed on the surface at a pitch of 333 μm.

A polyethylene terephthalate film (trade name: COSMOSHINE (registered trademark) A4300, manufactured by Toyobo Co., Ltd., thickness of 125 μm, refractive index of 1.57) was prepared as a first support. The surface of the first support was coated, according to a die coating method using a slot die described in Example 1 of JP2006-122889A, with a titanium oxide particle-containing polymerizable composition (composition type 1) prepared to have a refractive index of 1.55 according to the above-described item 1, under a condition of a transport speed of 24 m/min and dried at 60° C. for 60 seconds. Thereafter, the support was exposed at an irradiation does of 5 J/cm² so that the composition was cured in a nitrogen atmosphere using a UV exposure machine (EXECURE 3000W, manufactured by HOYA CANDEO OPTRONICS Corp.) while the uneven roller was pressed and the support was peeled off from the uneven roller so that an uneven shape (lens) was prepared on the surface.

Thereafter, the surface of the second support on which the light reflecting layer had been formed and the surface of the first support on which the uneven shape had not been formed were bonded to each other to produce a louver film J.

### Comparative Example 2

In Comparative Example 2, a privacy film (PF12.1WS (product number), manufactured by 3M Company) was used.

### Comparative Example 3

In Comparative Example 3, a louver film S was prepared in the same manner as in Example 14 except that the opening ratios of the light reflecting layer and the light absorbing layer with respect to the lens pitch were changed to 8%.

Further, lenses were arranged in a square shape in Examples 14 to 16 and Comparative Example 3 described above, and lenses were arranged in a hexagonal shape in Example 17. The numerical value of the opening ratio is noted as, for example, “25/5”, but the numerical value is a value represented by (opening width)/(numerical value represented by pitch). The latter numerical value is a numerical value represented by (opening area)/(area of square whose pitch is one side).

### EVALUATION

(Evaluation of Maximum Brightness)

On the light emission surface of the planar light source device prepared as described above, a brightness (Y0) measured for every degree from a polar angle of 0° (front direction) to a polar angle of 880 was obtained using a measuring device “EZ-Contrast XL88” (manufactured by ELDIM Co., Ltd.), and the maximum value of the brightness value was set as the maximum brightness. The maximum brightness was measured in a state (T0) where the louver film was not disposed on the planar light source device and in a state (T) where the louver film was disposed (T) thereon, and a ratio (T/T0) was calculated to obtain the maximum brightness ratio. The maximum brightness ratio was divided into the following four stages and evaluated as light use efficiency. As the value of the maximum brightness ratio acquired in the above-described manner increases, this indicates that the light use efficiency of the planar light source device becomes higher. The measurement results are listed in Table 1.

<Evaluation Standards>

AA: 1.3 or greater

A: 1.25 or greater

B: 0.8 or greater and less than 1.25

C: 0.65 or greater and less than 0.8

D: less than 0.65

(Evaluation of Directivity)

On the light emission surface of the planar light source device prepared as described above, the brightness (Y0) measured for every degree from a polar angle of 0° (front direction) to a polar angle of 88° was obtained using a measuring device “EZ-Contrast XL88” (manufactured by ELDIM Co., Ltd.), and the minimum polar angle at which the brightness value became half the brightness value in the front direction was set as the half width at half maximum. The minimum polar angle was divided into the following four stages and evaluated as directivity. The evaluation results of the directivity are listed in Table 1.

<Evaluation Standards>

A: less than 15°

B: 15° or greater and less than 20°

C: 200 or greater and less than 25°

D: 250 or greater

(Evaluation of Skirting)

Further, on the light emission surface of the planar light source device prepared as described above, the brightness (Y0) measured for every degree from a polar angle of 0° (front direction) to a polar angle of 88° was obtained using a measuring device “EZ-Contrast XL88” (manufactured by ELDIM Co., Ltd.), and the ratio between the brightness value in the front direction and the minimum brightness value at a polar angle of 60° was calculated as an SN ratio (=brightness in front direction/minimum brightness value at polar angle of 60°). The S/N ratio was divided into the following three stages and evaluated as skirting. The evaluation result of the skirting are listed in the columns of the SN ratio in Table 1.

<Evaluation Standards>

A: 50 or greater

B: 10 or greater and less than 50

C: less than 10

TABLE 1

| | | | Light reflecting layer | | | | | Light absorbing layer | | | | |
|---|---|---|---|---|---|---|---|---|---|---|---|---|
| | Second support | | | | | Opening | Opening | | | | Opening | Opening |
| | Refractive | Thickness | | Reflectivity | Pitch | width | ratio | | Reflectivity | Pitch | width | ratio |
| | index n1 | (μm) | Material | (%) | (μm) | (μm) | (%) | Material | (%) | (μm) | (μm) | (%) |
| Example 1 | — | — | — | — | — | — | — | CB | 6 | 100 | 50 | 50 |
| Example 2 | — | — | Ag | 97 | 100 | 50 | 50 | CB | 6 | 100 | 50 | 50 |
| Example 3 | — | — | — | — | — | — | — | CB | 6 | 100 | 35 | 35 |
| Example 4 | — | — | Ag | 97 | 100 | 35 | 35 | CB | 6 | 100 | 35 | 35 |
| Example 5 | 1.57 | 75 | — | — | — | — | — | CB | 6 | 100 | 35 | 35 |
| Example 6 | 1.57 | 75 | Ag | 97 | 100 | 35 | 35 | CB | 6 | 100 | 35 | 35 |
| Example 7 | 1.90 | 25 | — | — | — | — | — | CB | 6 | 100 | 35 | 35 |
| Example 8 | 1.90 | 25 | Ag | 97 | 100 | 35 | 35 | CB | 6 | 100 | 35 | 35 |
| Example 9 | — | — | CLC | 99 | 100 | 35 | 35 | CB | 6 | 100 | 35 | 35 |
| Example 10 | — | — | Ag | 97 | 100 | 25 | 25 | CB | 6 | 100 | 25 | 25 |
| Example 11 | — | — | Ag | 97 | 100 | 25 | 25 | CB | 6 | 100 | 25 | 25 |
| Example 12 | 1.57 | 75 | Ag | 97 | 100 | 25 | 25 | CB | 6 | 100 | 25 | 25 |
| Example 13 | — | — | Ag | 97 | 100 | 16 | 16 | CB | 6 | 100 | 16 | 16 |
| Example 14 | — | — | Ag | 97 | 100 | 25 | 25/5 | CB | 6 | 100 | 25 | 25/5 |
| Example 15 | — | — | Ag | 97 | 100 | 16 | 16/2 | CB | 6 | 100 | 16 | 16/2 |
| Example 16 | — | — | Ag | 97 | 100 | 25 | 25/5 | CB | 6 | 100 | 25 | 25/5 |
| Example 17 | — | — | Ag | 97 | 100 | 25 | 25/6 | CB | 6 | 100 | 25 | 25/6 |
| Comparative | 1.57 | 75 | Ag | 97 | 333 | 166.5 | 50 | — | — | — | — | — |
| Example 1 | | | | | | | | | | | | |
| Comparative | — | — | — | — | — | — | — | — | — | — | — | — |
| Example 2 | | | | | | | | | | | | |
| Comparative | — | — | Ag | 97 | 100 | 8 | 8/0.5 | CB | 6 | 100 | 8 | 8/0.5 |
| Example 3 | | | | | | | | | | | | |

| | | | | | | Difference | | | |
|---|---|---|---|---|---|---|---|---|---|
| | | | | | | between | | | |
| | | | Lens | | | thickness of | Evaluation | | |
| | First support | | | Curvature | | first support | Maximum | Evaluation | |
| | Refractive | Thickness | Refractive | radius | Pitch | and pitch of | brightness | of | SN |
| | index n2 | (μm) | index n3 | (μm) | (μm) | lens | ratio | directivity | ratio |
| Example 1 | 1.57 | 125 | 1.55 | 57 | 100 | 1.25 | C | B | C |
| Example 2 | 1.57 | 125 | 1.55 | 57 | 100 | 1.25 | B | B | C |
| Example 3 | 1.57 | 75 | 1.69 | 50 | 100 | 0.75 | C | B | B |
| Example 4 | 1.57 | 75 | 1.69 | 50 | 100 | 0.75 | B | B | A |
| Example 5 | 1.57 | 75 | 1.69 | 50 | 100 | 0.75 | B | B | A |
| Example 6 | 1.57 | 75 | 1.69 | 50 | 100 | 0.75 | B | B | A |
| Example 7 | 1.57 | 75 | 1.69 | 50 | 100 | 0.75 | B | B | A |
| Example 8 | 1.57 | 75 | 1.69 | 50 | 100 | 0.75 | A | B | A |
| Example 9 | 1.57 | 75 | 1.69 | 50 | 100 | 0.75 | B | B | A |
| Example 10 | 1.57 | 75 | 1.69 | 50 | 100 | 0.75 | A | A | B |
| Example 11 | 1.57 | 50 | 1.69 | 50 | 100 | 0.5 | A | A | A |
| Example 12 | 1.57 | 50 | 1.69 | 50 | 100 | 0.5 | A | A | A |
| Example 13 | 1.57 | 50 | 1.69 | 50 | 100 | 0.5 | A | A | A |
| Example 14 | 1.57 | 50 | 1.69 | 50 | 100 | 0.5 | B | A | A |
| Example 15 | 1.57 | 50 | 1.69 | 50 | 100 | 0.5 | B | A | A |
| Example 16 | 1.57 | 38 | 1.69 | 50 | 100 | 0.38 | B | A | A |
| Example 17 | 1.57 | 50 | 1.69 | 50 | 100 | 0.5 | AA | A | A |
| Comparative | 1.57 | 125 | 1.55 | 167 | 333 | 0.375 | C | D | C |
| Example 1 | | | | | | | | | |
| Comparative | — | — | — | — | — | — | D | B | A |
| Example 2 | | | | | | | | | |
| Comparative | 1.57 | 50 | 1.69 | 50 | 100 | 0.5 | D | A | C |
| Example 3 | | | | | | | | | |

Example 1 and Example 2 are examples according to the first aspect. Examples 3 to 13 are examples of the second aspect.

As shown in the results listed in Table 1, it was confirmed that the louver films of the examples have improved directivity while the light use efficiency is maintained as compared with the louver films of the comparative examples.

It was preferable to have the second support based on the comparison between Example 3 and Example 5 and between Example 4 and Example 6.

Further, it was found that the refractive index of the second support is preferably 1.6 or greater based on the comparison between Example 5 and Example 7 and between Example 6 and Example 8.

As the opening ratio decreases, the maximum brightness ratio increases and the directivity becomes excellent based on the comparison between Example 4 and Examples 10 to 13.

In Examples 10 to 13, the maximum brightness ratio is higher and the SN ratio becomes excellent compared to those in Comparative Example 3.

The maximum brightness ratio is higher in the hexagonal arrangement of the lenses than in the square arrangement based on the comparison between Examples 10 to 13.

### EXPLANATION OF REFERENCES

1, 1A, 1B: planar light source device
2, 2A, 2B: louver film
11, 11A, 11B: lens
12, 12A, 12B: first support
13: light reflecting layer
13a, 32a, 36a: surface
13b: second opening
14: diffusion plate
15: reflection plate
16: light source
17: second support
18: light absorbing layer
18b: first opening
18c: rear surface
20: reflective type polarizer
22: moire prevention point
30: liquid crystal display
32: liquid crystal cell
33: pixel
34: backlight-side polarizer
36: viewing-side polarizer
CL: optical axis

What is claimed is:

1. A louver film which is used for a planar light source device, the film comprising:
a plurality of lenses which are arranged at a constant pitch on an emission side of a light source;
a first support which is disposed on a side closer to the light source than the lenses and has a thickness greater than or equal to the pitch of the lenses a refractive index of 1.5 or greater, and
a light absorbing layer which is disposed on a side closer to the light source than the first support,
wherein the light absorbing layer has a first opening and an opening ratio of the first opening is in a range of 30% to 70%.

2. The louver film according to claim 1,
wherein the refractive index of the first support is 1.6 or greater.

3. A louver film which is used for a planar light source device, the film comprising:
a plurality of lenses which are arranged at a constant pitch on an emission side of a light source and have a refractive index of 1.65 to 1.9;
a first support which is disposed on a side closer to the light source than the lenses, has a thickness smaller than the pitch of the lenses, and has a refractive index of 1.4 to 1.65; and
a light absorbing layer which is disposed on a side closer to the light source than the first support,
wherein the light absorbing layer has a first opening, and
an opening ratio of the first opening is in a range of 10% to 70%.

4. The louver film according to claim 1, further comprising:
a light reflecting layer which is disposed on a side closer to the light source side than the light absorbing layer and comprises a second opening,
wherein the light reflecting layer has a reflectivity of 90% or greater,
an opening ratio of the second opening is the same as the opening ratio of the light absorbing layer, and
the light absorbing layer and the light reflecting layer are disposed in a state in which the first opening and the second opening are aligned.

5. The louver film according to claim 3, further comprising:
a light reflecting layer which is disposed on a side closer to the light source side than the light absorbing layer and comprises a second opening,
wherein the light reflecting layer has a reflectivity of 90% or greater,
an opening ratio of the second opening is the same as the opening ratio of the light absorbing layer, and
the light absorbing layer and the light reflecting layer are disposed in a state in which the first opening and the second opening are aligned.

6. The louver film according to claim 1,
wherein each of the first openings is provided for each of the lenses, and
the first opening is deviated from an optical axis of the lens.

7. The louver film according to claim 3,
wherein each of the first openings is provided for each of the lenses, and
the first opening is deviated from an optical axis of the lens.

8. The louver film according to claim 4,
wherein the first opening and the second opening are provided for each of the lenses, and
the aligned first opening and second opening are deviated from an optical axis of the lens.

9. The louver film according to claim 1,
wherein a second support is disposed on a side closer to the light source than the light absorbing layer.

10. The louver film according to claim 3,
wherein a second support is disposed on a side closer to the light source than the light absorbing layer.

11. The louver film according to claim 4,
wherein the second support is disposed on a side closer to the light source than the light reflecting layer.

12. The louver film according to claim 8,
wherein the second support is disposed on a side closer to the light source than the light reflecting layer.

13. The louver film according to claim 4,
wherein the light reflecting layer includes a cholesteric liquid crystal layer.

14. The louver film according to claim 8,
wherein the light reflecting layer includes a cholesteric liquid crystal layer.

15. The louver film according to claim 9,
wherein the second support has a refractive index of 1.6 or greater.

16. The louver film according to claim 11,
wherein the second support has a refractive index of 1.6 or greater.

17. A planar light source device comprising:
the louver film according to claim 1; and
the light source.

18. A planar light source device comprising:
the louver film according to claim 2; and
the light source.

19. The planar light source device according to claim 17, further comprising:
a reflective type polarizer which is disposed between the louver film and the light source.

20. A liquid crystal display device comprising:
the planar light source device according to claim 17; and
a liquid crystal panel.
